(19) United States
(12) Patent Application Publication
(10) Pub. No.: US 2012/0216015 A1
(43) Pub. Date: Aug. 23, 2012

(54) System and method to concurrently execute a plurality of object oriented platform independent programs by utilizing memory accessible by both a processor and a co-processor

(76) Inventor: Sumanranjan S. Mitra, Mumbai (IN)

(21) Appl. No.: 13/200,990

(22) Filed: Oct. 6, 2011

Related U.S. Application Data
(60) Provisional application No. 61/445,312, filed on Feb. 22, 2011.

(51) Int. Cl. G06F 9/02; G06F 9/30

(52) U.S. Cl. 712/28; 712/E09.028; 712/E09.002

(57) ABSTRACT

The invention achieves efficient execution of programs belonging to an object oriented platform independent language technology like Java, .NET in a multitasking environment by utilizing a processor, a co-processor (executing machine independent instructions) and memory that is accessed by both said processor and said co-processor. The co-processor is agnostic of format of the executables of the object oriented platform independent programs and operates on a composite data structure to execute a program. The composite data structure is a logical representation of an objected oriented platform independent computer program and includes instructions, object pointers, metadata, etc. Said composite data structure is independent of any object oriented platform independent technology like Java, .NET, etc. The co-processor relies on a native program to reduce executable file(s) of an objected oriented platform independent program to the said composite data structure. The invention allows the co-processor to perform scheduling, context switching and aids garbage collection apart from executing the programs of languages like Java, .NET efficiently. The invention aims at providing a co-processor as an alternative to using complex software like Just In Time (JIT) compilers to achieve high performance execution of object oriented platform independent language programs.

### CROSS REFERENCE TO RELATED APPLICATION

This non provisional patent application claims priority to the U.S. provisional patent application having Ser. No. 61/445,312, having filing date Feb. 22, 2011, the entire disclosure of which is incorporated by reference.

### TECHNICAL FIELD & BACKGROUND

Object oriented, platform independent languages like Java, etc. are programming language of choice for application development in personal, server and embedded computing systems. These languages are computer platform/processor independent, i.e. these programs need not be compiled for each processor (machine), like native programs written in languages like ‘C’ which needs to be compiled for the target processor. Thus the phrase ‘compile once, run anywhere’ is associated with these languages. These languages are object oriented, i.e. a program is structured as one or more classes where each class has its own set of methods (functions containing processor independent executable instructions), static data, and other information necessary for program execution. The programs written in these languages are traditionally executed by a virtual machine (runtime) on a computer. The virtual machines employ interpretation of the machine independent instructions (interpreter) or just in time (JIT) compilation. These techniques are computing resource (memory, CPU cycles, etc.) intensive and do not give high program execution speed when compared with native programs. These programs support multithreading, i.e. each program can have multiple threads (paths of execution) internal to the program. Also multiple programs can be concurrently executed in a computer. The virtual machine is responsible to internally manage the allocation of CPU bandwidth to the individual threads of a program. These programs support schemes like garbage collection (memory management) to detect and free up dynamic data that are not in use (unreachable) by the program.

Programs written in platform independent languages like Java, .NET, etc. are compiled to generate machine (processor) independent instructions (opcodes and operands). These operands and opcodes along with other program data and metadata are stored in computer program files of different types e.g. ‘.class’ (Java). The names and format of these files are different for different technologies, e.g. Java and .NET. Also for the same language, e.g. Java the files from different technology framework, e.g. Standard Java, Android, etc. the format and names of files can be different. These files are hereafter referred to as executable files. Executable files can be a collection of individual ‘.class’ files or a single file created by combining a number of ‘executable’ files, e.g. .jar (Standard Java), .dex (Android), .exe (.NET), etc. The machine independent instructions (hereafter referred to as byte codes/instructions) are executed by a general purpose processor (hereafter referred to as processor) e.g., ARM, Pentium, PowerPC, etc. by using software like Interpreter or Just In Time (JIT) Compilers.

The following hardware solutions are employed as an alternative/augmentation to software like Interpreter and JIT to get better performance in executing byte codes especially in VLSI System on Chips (SoCs) and other computing platforms.

1. Dedicated second general purpose processor to execute the byte codes running interpreter or JIT compiler.

Disadvantages
1. Second processor leads to increase in cost financially as well as in terms of resources like logic gates, power consumption, etc.
2. Legacy computing systems need to redesign extensively at the hardware level for accommodating the additional processor.
3. Legacy software running on the system needs to be redesigned extensively to accommodate the second processor.
4. Software like interpreter and JIT consume significant memory and other computing resources.

2. A co-processor which natively executes the byte codes offloaded to it by the processor.

### Advantages

1. Relatively lesser usage of logic gates and power.
2. Legacy computing systems need not be redesigned extensively at the hardware level.
3. The co-processor appears like an on-chip/on-board peripheral and legacy software running on the system need not be redesigned. Just an additional software component (device driver) needed to control the co-processor needs to be added to the legacy virtual machine.
4. No need for software like Interpreter or JIT.

### SUMMARY OF THE INVENTION

The present invention is based on a co-processor solution. The invention describes a technique using a co-processor which gives a platform independent program execution performance equivalent to (or more than) what can be achieved by employing a dedicated (second) processor. Moreover, the hardware logic of the co-processor can be kept simple with the present invention.

Employing a co-processor (in conjunction with a general purpose processor) to execute the byte codes is a known mechanism for fast execution of the byte codes. Most of the byte codes are executed natively by the co-processor. The merit of a co-processor lies in executing each byte code in minimum clock cycles. This processor and co-processor arrangement leads to parallel execution of native and byte code instructions positively impacting system throughput.

The co-processor interrupts the processor whenever it needs to perform tasks it is not capable of doing, e.g. handling un-supported byte code, fetching of data/byte codes from memory external to co-processor (hereafter referred to as external memory), invoking programs native to processor, exception handling, etc. This interruption of the processor consumes bandwidth of the processor (and other computing resources) and can negatively impact throughput of the computing system. The number of the interrupts to processor from co-processor has to be kept low to ensure high system throughput. Sophisticated co-processors can fetch byte code and data from external memory thereby reducing the dependency on the processor.

The present invention relates co-processors that can access external memory, i.e. the co-processor is Bus Mater Capable a.k.a., Direct Memory Access (DMA) capable.

However just fetching byte code and data from the external memory is not enough for an efficient co-processor design because of challenges inherent to computer programs developed using platform independent language technology. These challenges can lead to the co-processor logic to become extremely complicated if not for the present invention.

Some of these challenges are listed below.
a. Apart from data created at compile time, programs generate unpredictable amounts of data during execution (hereafter referred to as dynamic data). Each of these data is resident in external memory locations. The co-processor needs to have the address of the unpredictable number of external memory locations to access the data.
b. The executable files contain byte codes and data created at compile time in a format which may not be best suited to be parsed by co-processor hardware logic. Complex hardware logic is needed in the co-processor to extract byte codes and data from the executable file(s).
c. Different flavors of a same language technology (such as Java) exist and can have different formats of the executable files. Legacy Java uses .class/.jar format while Android uses the .dex format. A co-processor designed to execute both the flavors of a given language will end up having complex and large hardware logic.
d. At a given point of time unpredictable number of programs (each with an unpredictable number of threads) needs to be executed concurrently by the co-processor in a computing system.
Thus it can be inferred that a co-processor design needs to take into account various aspects to become a practical solution for high performance byte code execution.

It is an object of the present invention to provide a system and method that facilitates simple hardware logic implementation in a co-processor.

It is an object of the invention to provide a system and method that facilitates a co-processor to access instructions and data in minimal cycles during execution thereby positively impacting overall system throughput.

It is an object of the invention to provide a system where the number of objects and threads in a platform independent program and number of programs concurrently executing is not constrained at the design level.

It is an object of the invention to provide a system and method that facilitates simpler implementation of instruction and data caching logic inside a co-processor, which positively impacts overall system throughput and reduces the necessity to access slower external memory frequently.

It is an object of the invention to provide a system and method with a co-processor that appears as a DMA capable peripheral, rather than a second processor core to the main processor. The present invention is instrumental in bringing the co-processor solution at par with respect to performance that can be achieved with a dedicated second processor.

It is an object of the invention to provide a system and method where relatively complex hardware and software modifications are not necessary to integrate a co-processor into new and legacy computing systems.

It is an object of the invention to provide a system and method where multiprocessing (symmetric/asymmetric) operating systems need not be employed, which is necessary in case more than one processor in the computing system is needed.

It is an object of the invention to provide a system and method where more than one instance of an operating system driving each processor is not necessary. Such an arrangement becomes necessary in case of more than one processor is utilized in the computing system.

It is an object of the invention to provide a system and method where computing hardware executing platform software (operating system, device drivers and native applications) and platform independent programs (often developed and distributed by un-trusted 3^{rd} party vendors) are physically separate, which positively impacts the security of the computer system.

It is an object of the invention to provide a system and method where multiple instances of the runtime (virtual machine) can concurrently execute multiple platform independent programs concurrently.

It is an object of the invention to provide a system and method where runtime (virtual machines) of platform independent language technology, though utilizing services of a hardware co-processor can freely change memory locations of objects, class data, etc. necessary to address issues like memory fragmentation.

It is an object of the invention to provide a systems and method where the hardware co-processor can concurrently execute a plurality of object oriented platform independent programs.

It is an object of the invention to provide a system and method not coupled with a specific, processor belonging to a single vendor. The co-processor can be coupled with a general purpose processor, a digital signal processor, MCU, etc.

Inventors have previously attempted to execute Java (and other object oriented programs) directly in hardware. There are hardware solution like Pico Java, Ajile JEMCore, Cjip, Ignite PSC 1000, Femto Java, Komodo Java and Java Optimized Processor. All these solution differ significantly from the system and method of the present invention in at least one of the following points.
a. Does not operate using any form of (composite) data structure that includes data, instructions, metadata, etc as described in system of present invention;
b. Does not involve any native processor as described in the system of present invention;
c. Does not implement support for object oriented instructions for invoking methods and accessing object attributes as described in method of present invention;
d. Imposes restrictions (no dynamic creation of threads, maximum number of concurrently running programs, etc) on programs of the object oriented programming language technology; and
e. Can fetch instructions from internal cache and not external memory. Dependency on another agent to move instructions into internal cache.

### BRIEF DESCRIPTION OF THE DRAWINGS

The present invention will be described by way of exemplary embodiments, but not limitations, illustrated in the accompanying drawing in which like references denote similar elements, and in which:

FIG. 1 illustrates a block diagram of a system with a co-processor interfacing with a system on chip, in accordance with one embodiment of the present invention.

FIG. 2 illustrates a front side perspective view of a PCI e-Card inserted in a server, in accordance with one embodiment of the present invention.

FIG. 3 illustrates a block diagram of a typical arrangement of the various elements of a composite data structure, in accordance with one embodiment of the present invention.

FIG. 4 illustrates a block diagram of a plurality of hardware and software components, in accordance with one embodiment of the present invention.

FIG. 5 illustrates a block diagram of an object field access using an object reference and field offset, in accordance with one embodiment of the present invention.

FIG. 6 illustrates a block diagram of a co-processor invoking a method using an object reference, in accordance with one embodiment of the present invention.

FIG. 7 illustrates a block diagram of a co-processor checking a plurality of objects being accessible in a program during garbage collection, in accordance with one embodiment of the present invention.

FIG. 8 illustrates a block diagram of a data cache arrangement using various components of a system of a plurality of object oriented platform/processor independent languages to operate by utilizing memory accessible by both a processor and a co-processor, in accordance with one embodiment of the present invention.

FIGS. 9A and 9B illustrate a plurality of flowcharts that describe the operation of a native program (virtual machine) and a co-processor respectively during loading of a platform independent program (Java) and executing a plurality of initial instructions (main method) of the native program, in accordance with one embodiment of present invention.

FIGS. 10A and 10B illustrate a plurality of flowcharts that describe an operation of a co-processor and a native program (virtual machine) respectively during the creation of an object instance and writing into an attribute of the created object, in accordance with one embodiment of present invention.

FIGS. 11A and 11B illustrate a plurality of flowcharts that describe operation of a co-processor and a native program (virtual machine) respectively effecting invocation of a non-static function (method), in accordance with one embodiment of present invention.

FIG. 12 is a flowchart describing the flow of operation of the co-processor during, the process of context switching between two platform independent programs without intervention from processor, in accordance with one embodiment of present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be, apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention. However, the order of description should not be construed as to imply that these operations are necessarily order dependent. In particular, these operations need not be performed in the order of presentation.

The phrase ‘in one embodiment’ is used repeatedly. The phrase generally does not refer to the same embodiment, however, it may. The terms “comprising”, “having” and “including” are synonymous, unless the context dictates otherwise.

The system of the invention includes
a. Processor—The processor executes native programs like the operating system, peripheral device drivers, native applications and virtual machine (runtime) of the object oriented platform independent language program (e.g. Java). A native program which is the device driver of the co-processor subsequently described in the system is also executed by the processor.
b. Co-processor—The co-processor includes hardware logic to natively execute instructions of an object oriented platform independent language technology (e.g. Java, .NET). Apart from executing said instructions the co-processor also includes hardware logic that can do operations like context switching, program scheduling and aid garbage collection. The co-processor is agnostic of the format of the executable(s) in which said instructions are stored and fetches instructions, data, metadata, etc from a composite data structure described subsequently in the system. The term ‘co-processor’ and ‘co-processor hardware logic’ means the same and is used interchangeably in the descriptions.
c. Composite data structure—Each object oriented platform independent program (e.g. Java program) is represented by a composite data structure resident in memory. This composite data structure is created by the native program (subsequently described in system) during program loading in Memory (subsequently described in system) and is used by the co-processor to execute the said object oriented platform independent program. Pluralities of these composite data structures can be present in memory each corresponding to an object oriented platform independent language (e.g. Java) program active in the computing system. The format of the composite data structure makes it possible to achieve the mentioned objectives of the invention. The composite data structure is so designed that every part of the data structure can be reached by the co-processor hardware logic in minimum cycles using just a single pointer to the composite data structure and indexes derived during course of object oriented platform independent (Java) program execution.
d. Memory—The said composite data structures(s) are resident in memory that is accessible by both said processor and co-processor.
e. Native Program—A native program executing on said processor creates, modifies and deletes the said composite data structure(s) in said memory. The native program can also be seen as the ‘device driver’ of the co-processor. The native program can be resident in the computing system as a dynamically linkable library or can be statically linked to the runtime of the object oriented platform independent language technology that the co-processor executes. The native program and the co-processor hardware logic are aware of the format of the composite data structure and its components.
f. Bus Interface—The bus interface provides interfacing between the hardware components of the system, the processor, co-processor and memory. The bus interface makes it possible for both the co-processor and processor to perform read and write access to the memory. The bus interface makes possible for the processor to read and write the co-processor registers. The bus interface makes possible the co-processor to read and write access various memory locations of the computer system. The bus interface can be on chip bus, buses like PCIe or more complex buses.

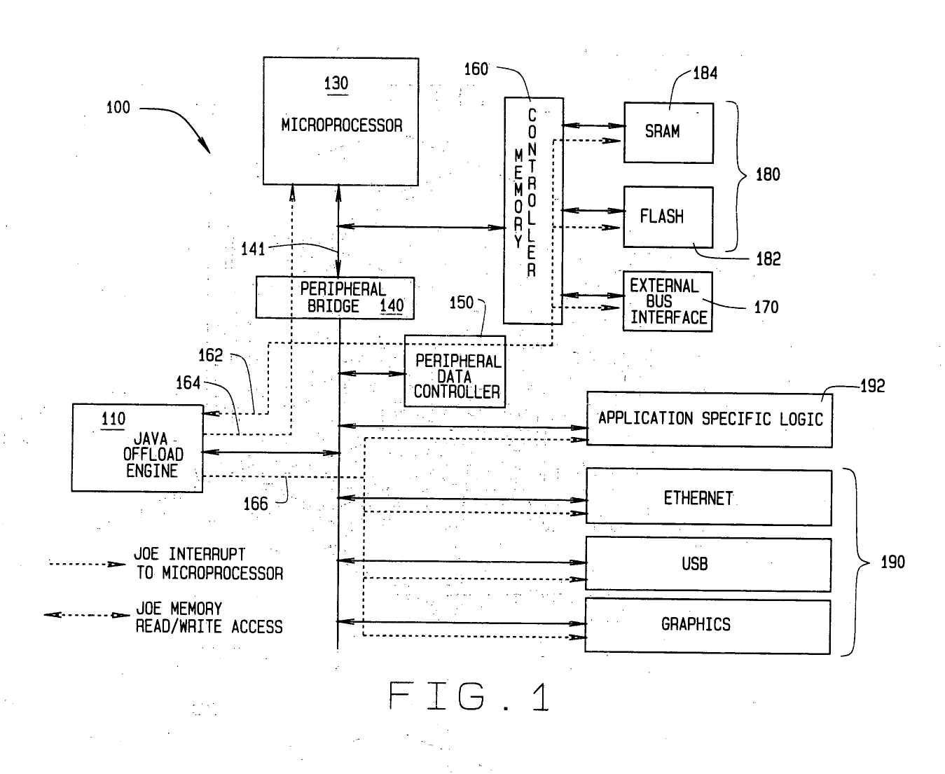

FIG. 1 illustrates a block diagram of a system 100 with a co-processor 110 interfacing with a processor 130 in a system on chip (SoC) arrangement, in accordance with one embodiment of the present invention.

The system 100 includes a co-processor 110, a processor 130, a peripheral bridge 140, a peripheral data controller 150, a memory controller 160, an external bus interface 170, memory 180, a plurality of peripherals 190.

The co-processor 110 is a JAVA offload engine, the system can include any number and combination of subsequent peripherals and components. The processor 130 can be any suitable type of processor such as a general purpose processor or a digital signal processor or a microcontroller. The peripheral bridge 140 is part of the system on chip 120 and serves as a communication bridge between the processor 130 and the co-processor 110 and can be any suitable type of peripheral bridge. The peripheral bridge is a part of the bus interfacing 141 which interfaces the processor 130, the co-processor 110, the internal memory 180 and external memory via external bus interface 170. The peripheral data controller 150 is part of the system 100 and facilitates peripherals to read/write memory both internal and, external to the system 100 through the memory controller 160. The memory controller 160 is instrumental in facilitating memory access by the processor 130 and co-processor 110. The external bus interface 170 is in communication with the memory controller 160 and can be used by the processor 130 and co-processor 110 to communicate with any suitable external peripherals and memory. The memory 180 includes flash memory 182 and SRAM memory 184. The memory 180 is accessed by the co-processor 110 through the memory controller 160 and the peripheral data controller 150 with the co-processor 110 having memory read and write capability. There is an application specific logic 192. Memory and peripherals external to system 100 are accessed 162 by the co-processor 110 through the peripheral data controller 150, memory controller 160 and external Bus Interface 170. Memories internal to system are accessed 162 by the co-processor 110 through the peripheral data controller 150 and memory controller 160. The co-processor 110 interrupts the processor 164. The co-processor 110 can optionally read/write access 166 the registers and memory locations internal to the peripherals 190 and application specific logic 192.

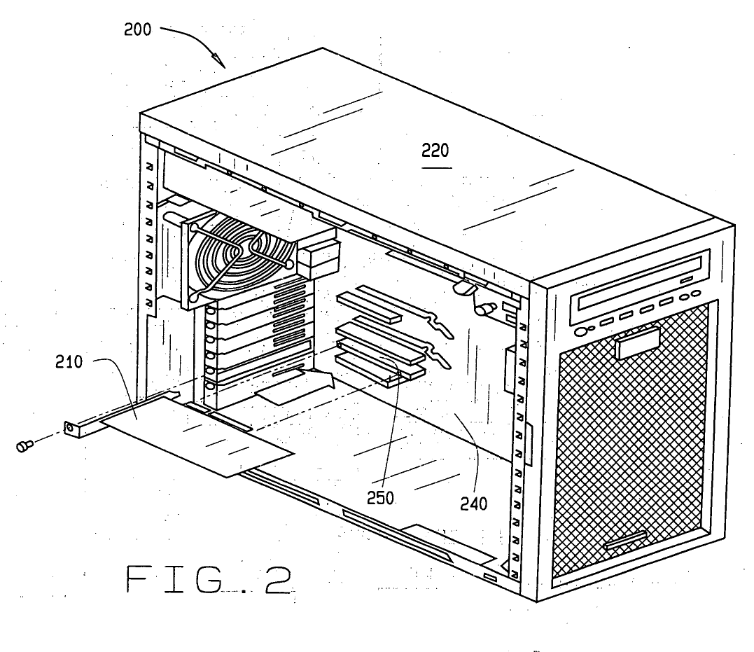

FIG. 2 illustrates a front side perspective view of a system 200 with a PCI e-card 210 inserted in a server 220, in accordance with one embodiment of the present invention.

The system 200 includes a PCIe card 210, a server 220, a co-processor (Java co-processor) resident on the PCIe card 210, a motherboard 240 and a PCIe slot 250 on the motherboard 240. The PCIe card 210 is external to the system 200 and can be attached to use the services of the co-processor resident on the PCIe card 210. The motherboard 240 can be any suitable computer board that includes one or more processors, memory, PCIe slots and other components. The co-processor can reside on the PCI e-card 210 or on the mother board 240. The Java co-processor services can be used when the PCI e-card 210 is inserted into the PCI card slot 250.

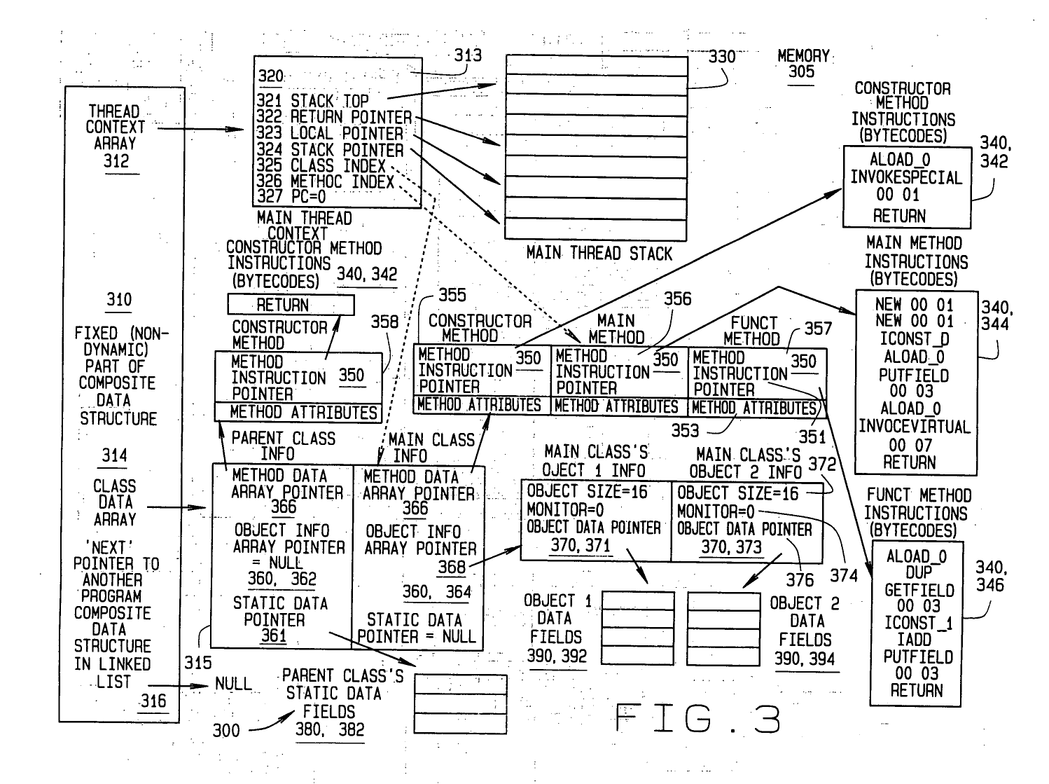

FIG. 3 illustrates a block diagram of various elements of a composite data structure 300 corresponding to a Java program at any given point during course of execution of said Java program, in accordance with one embodiment of the present invention.

The composite data structure 300 is resident in memory 305, includes a fixed part 310, a main thread context 320, a main thread stack 330, a plurality of method instructions 340, a plurality of method info instance 350, a pair of class info instance 360 one corresponding to a class named ‘Main’ other corresponding to class named ‘Parent’, a plurality of main class's objects info instances 370 namely ‘Object1’ and ‘Object2’, a plurality of Parent class's static data fields 380 and a plurality of Object data fields 390.

The memory 305 has all of the elements of the composite data structure 300 residing in the memory 305. The fixed part 310 includes a thread context array pointer 312 pointing to an array including a main thread context 313, a class data array pointer 314 and a ‘next pointer’ 316. The main thread context 313 includes a stack top pointer 321, a return pointer 322, a local pointer 323, a stack pointer 324, a class index 325, a method index 326 and a program counter (pc) 327. The'main thread stack 330 holds a plurality of data, object references and saved register contents. The method instructions 340 are a plurality of Java byte codes and include a plurality of ‘constructor’ method instructions 342, ‘main’ method instructions 344 and ‘funct’ method instructions 346. The method data array of Main class info instance 364 includes a constructor method data instance 355, a main method data instance 356 and a Funct method data instance 357. The method data array of Parent class info instance 362 includes a constructor method data instance 358. Each of the method data instance includes an instruction pointer 351 and a plurality of method attributes 353. The pair of class info 360 are a parent class info 362 and a main class info 364. Each class info 360 includes a method data array pointer 366, an object info array pointer 368 and a static data pointer 361. The main class objects info 370 includes main class's object 1 info 371 and main class's object 2 info 373. Each class objects info 370 includes an object size 372, a monitor 374 and an object data pointer 376. The class data fields 380 are parent class's static data attributes 382 and can include any suitable number of parent class's static data fields (attributes) 382. The data fields 390 of two objects, object 1 and object2 are illustrated. Object 1 data field 392 and an object 2 data field 394 where both object data fields can be any suitable number of object data fields (class's non-static attributes) 390.

The fixed part of the composite data is seen to have a thread context array with a single element (main thread), a class data array with two elements corresponding to the two classes Parent and Main that have been loaded at program start and a next pointer corresponding to the list of composite data structures. The ‘next’ pointer is NULL as the current Java program is the only program running in the computing system. The thread context info has pointers to various points in the thread stack. These are used to store the co-processor register copies (stack top, return pointer, local pointer, stack pointer) when the thread is context switched out. The combination of class index, method index and program counter ‘pc’ are used in conjunction to store the exact instruction of method which the thread should execute when chosen to run in future by co-processor:

Parent class has just one method (constructor) hence a single element method array. It has static data fields hence pointer to the static data fields and the static data fields are shown. Parent class has no objects instantiated. Main class has 3 methods (constructor, main and Funct) hence a 3 element method array. 2 objects of Main class have been instantiated hence a two element object info array is seen. The object info elements each have a pointer to the object's data fields. All the method data elements have pointers to their method's instructions (Java byte codes). The figure shows how all the components of the composite data structure are interconnected and can be accessed through a pointer to the fixed part of composite data structure. The indexes and offsets to access the correct element, field, etc. are derived during the course of program execution.

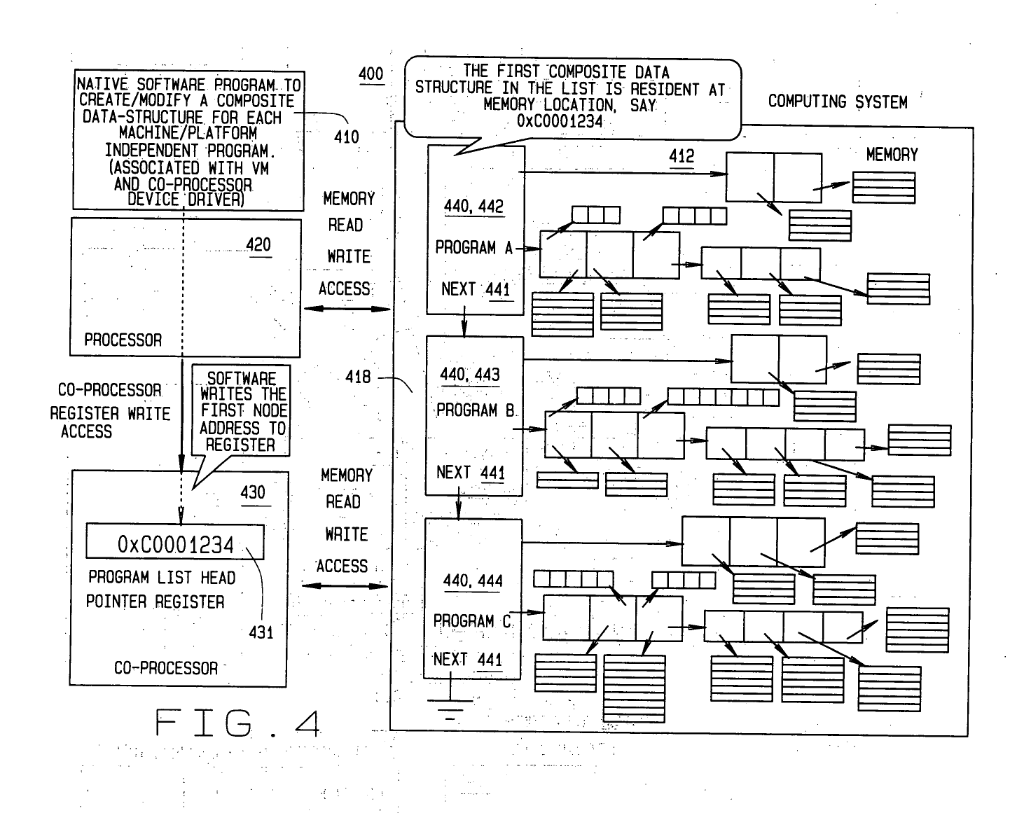

FIG. 4 illustrates a block diagram of a plurality of hardware and software components 400, in accordance with one embodiment of the present invention.

The hardware and software components 400 include a native software program 410, a processor 420, a Java co-processor 430, a memory 412 and a plurality of composite data structure 440 each corresponding to a platform independent program being executed by the Java co-processor 430. The native software program 410 creates a composite data structure 440 for each machine/platform independent program. The native software program 410 modifies contents of composite data structure 440 associated with each machine/platform independent program. The native software program 410 deletes the entire composite data structure 440 associated with each machine/platform independent program upon termination of said machine/platform independent program. The native software program 410 writes the first node address to a pre-defined Java co-processor register 431. The processor 420 can be any suitable type of processor previously mentioned that has memory read and write access to the memory 412. The Java co-processor 430 has memory read and write access to the memory 412. A plurality of composite data structure 440 is chained together like a linked list 418. Each composite data structure 440 resides at a specific memory location on the memory 412. The said location (pointer) is present in the ‘Next’ 441 field of the previous composite data structure. The Java co-processor 430 hardware logic can traverse the linked list of composite data structure 440 during operation by using the pointer programmed in register 431 by native software program 410 and the ‘Next’ 441 pointer of each composite data structure 440. This allows the said hardware logic to access multiple Java programs with just a single pointer to a composite data structure. The said hardware logic access the plurality of composite data structures to choose a program to run during context switching in a multitasking environment.

The processor, co-processor, memory, native software that create and manage the composite data structure is illustrated. The composite data structure list resident in memory is shown to have 3 nodes corresponding to 3 platform (machine) independent programs A, B and C running concurrently in the system. Each node corresponds to a platform independent program (Java program). The co-processor ‘Program List Head Pointer’ register is programmed the start address of the first composite data structure node. The co-processor can traverse the list of all nodes using this register content and ‘next’ pointer present in each node. Both processor and co-processor have read-write access to the memory. The processor can read or write the co-processor registers.

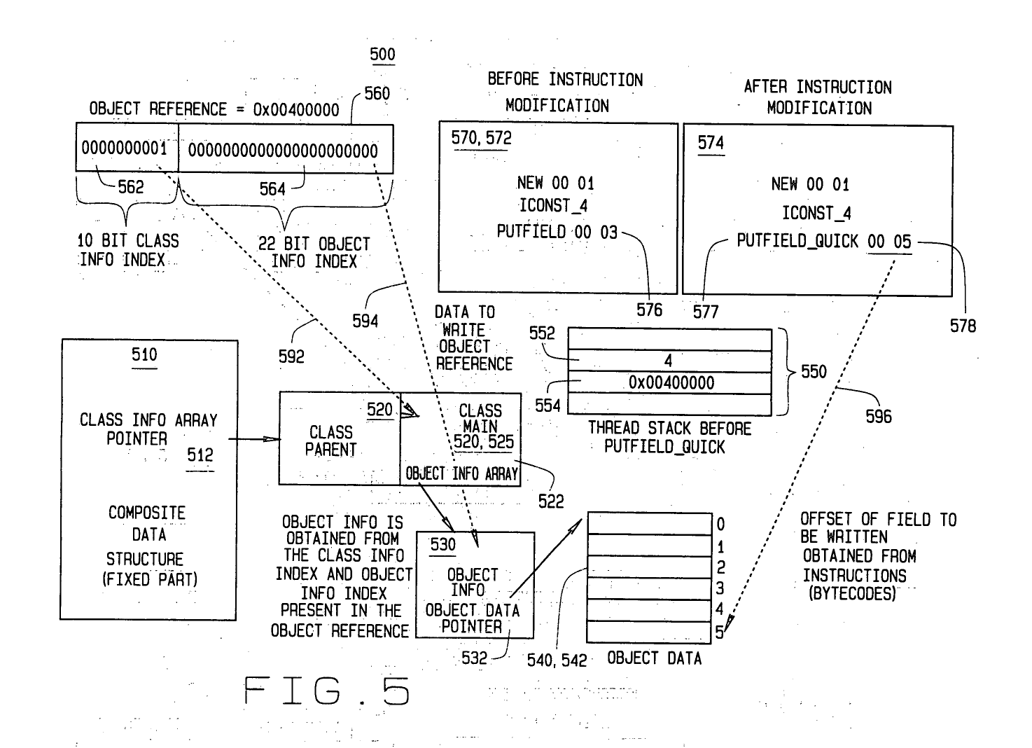

FIG. 5 illustrates a block diagram 500 of an object field (non static class attribute) access using an object reference and attribute offset, in accordance with one embodiment of the present invention.

The block diagram 500 includes a composite data structure 510, a class info instances for a class named parent and class named main 520, an object info instance 530, a plurality of object data fields 540, a thread stack 550, an object reference with its components visible 560 and a set of Java instructions 570 to create an object and write a value in a field of the object originally indicated by operands ‘00 03’ 576. The composite data structure 510 includes a class info array pointer 512 as well as other information and features about the composite data structure 510 previously mentioned. The class info instance of class main 525 includes an object info array 522 and is an element of the array pointed by class info array pointer 512 in the composite data structure 510. The object info 530 includes an object data pointer 532 and is an element of the object info array 522. The object data 540 includes a plurality of object data fields each of fixed size 542 and is pointed to by the object data pointer 532. The thread stack 550 includes data to write 552 and an object reference 554 whose components are displayed 560. The object reference 560 includes a 10 bit Class Index 562 and a 22 bit Object Info Index 564. The instructions before modification of ‘PUTFIELD 00 03’ 572 and after replacement of ‘PUTFIELD 00 03’ with ‘PUTFIELD_QUICK 00 05’ 574 is illustrated. The instruction PUTFIELD 00 03 576 is replaced with instruction PUTFIELD_QUICK 00 05 577 by native software during execution of PUTFIELD 00 03 576 instruction. 00 05 578 operands of instruction PUTFIELD_QUICK 00 05 577 serves as index into the object data 540 and can be addressed as ‘attribute offset’.

The co-processor hardware logic's use of the pointer to Class Info Array 512, class index 562 of object reference 554 present in the thread stack 550, Object Info Array pointer 522 of class info instance of class main 525, object index 564 of object reference 554 present in the thread stack 550 and the operands 00 05 578 of instruction PUTFIELD_QUICK 00 05 577 to determine the appropriate location of the correct object field to write the data 552 is illustrated. The class index 562 is used to resolve 592 the class info instance and the object info array pointer 522 is thus derived. The object index 564 is used to resolve 594 the object info instance 530 which is an element of the derived object info array. The object data pointer 532 is derived and points to contiguous memory region where the object's attribute are resident 540. The attribute offset included in the operands 578 are used to resolve 596 the offset at which the concerned attribute is resident.

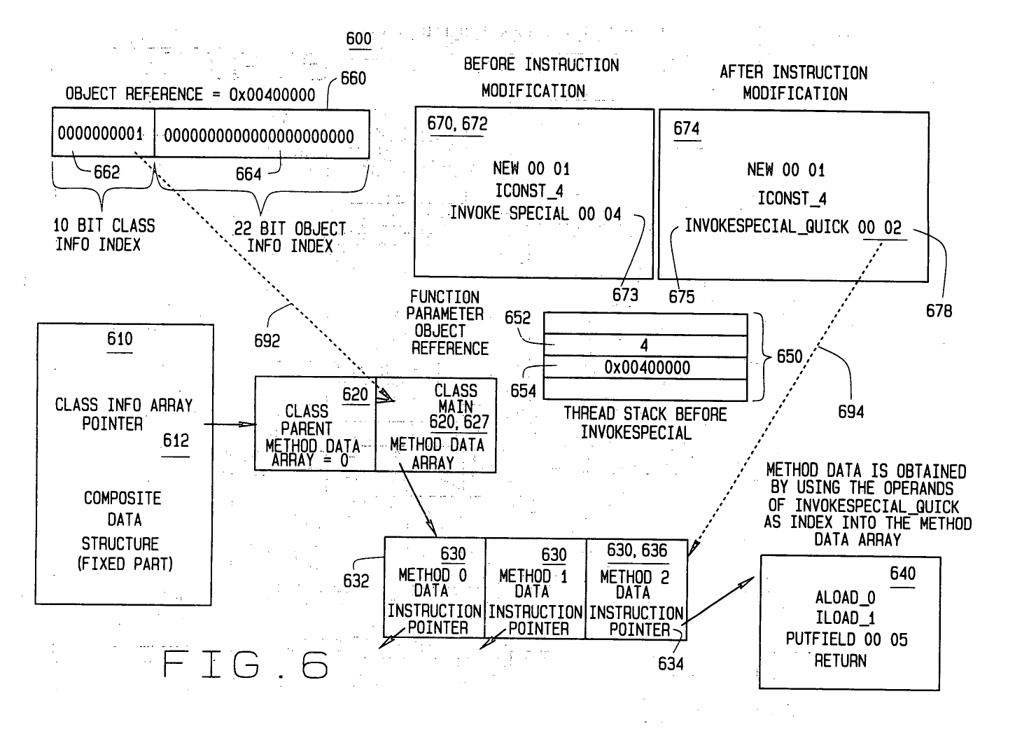

FIG. 6 illustrates a block diagram 600 of a co-processor invoking a method using an object reference, in accordance with one embodiment of the present invention.

The block diagram 600 includes a composite data structure 610 corresponding to a Java program at any arbitrary point of time during course of the program execution, a plurality of class info instances 620, a plurality of method data instances 630, method data instance for Method 2 636, Java bytecodes of Method 2 method 640, a thread stack 650, an object reference to be used for invoking method 654, said object reference's 654 components visible 660, a parameter to be passed to method being invoked 652 and Java instructions that create an object and subsequently invoke a method using the newly created object 670. The composite data structure 610 includes a class info array 612 as well as other information and features about the composite data structure 610 previously mentioned. Each class info instances 620 include a pointer to method data array 622. The method data array 632 includes 3 elements each corresponding to a method belonging to class Main 632. The Java instructions of Method 2 640 are pointed to by the Method Instruction Pointer 634. Each Method data instance has this pointer pointing to the method's instructions. The thread stack 650 includes a function parameter 652 and an object reference 654 with its components shown 660. Each object reference components 660 includes a 10 bit Class Index 662 and a 22 bit Object Info Index 664. The instructions before modification of ‘INVOKESPECIAL 00 04’ 672 and after replacement of ‘INVOKESPECIAL 00 04’ with ‘INVOKESPECIAL_QUICK 00 02’ 674 by native program running on processor is illustrated. The instruction INVOKESPECIAL 00 04 673 is replaced with instruction INVOKESPECIAL_QUICK 00 02 675 by native software during execution of INVOKESPECIAL 00 04 673 instruction. The ‘00 02’ 678 operands of instruction INVOKESPECIAL_QUICK 00 02 675 serves as index into the method data array 632 of main class info instance 627. The co-processor hardware logic's use of the pointer to Class Info Array 612, class index 662 of object reference 654 present in the thread stack 650, Method data Array 632 of class info instance of class main 627, and the operands 00 02 678 of instruction INVOKESPECIAL_QUICK 00 02 675 to determine the correct address of the byte-codes (instructions) 640 of function to be invoked is illustrated.

The instructions before and after modification by the virtual machine are illustrated. The object reference includes indexes into the object's class and object info array of the object's class. The class info index in the object reference is being used 692 by co-processor's hardware logic to access the class info instance of class whose object is used to invoke method. The modified operands of INVOKESPECIAL_QUICK instruction is used as index to access 694 the method data instance of the method to be invoked. The instructions of the method to be invoked are shown and can be accessed using the pointer present in method data instance. The thread stack before the co-processor executes the INVOKESPECIAL instruction is shown.

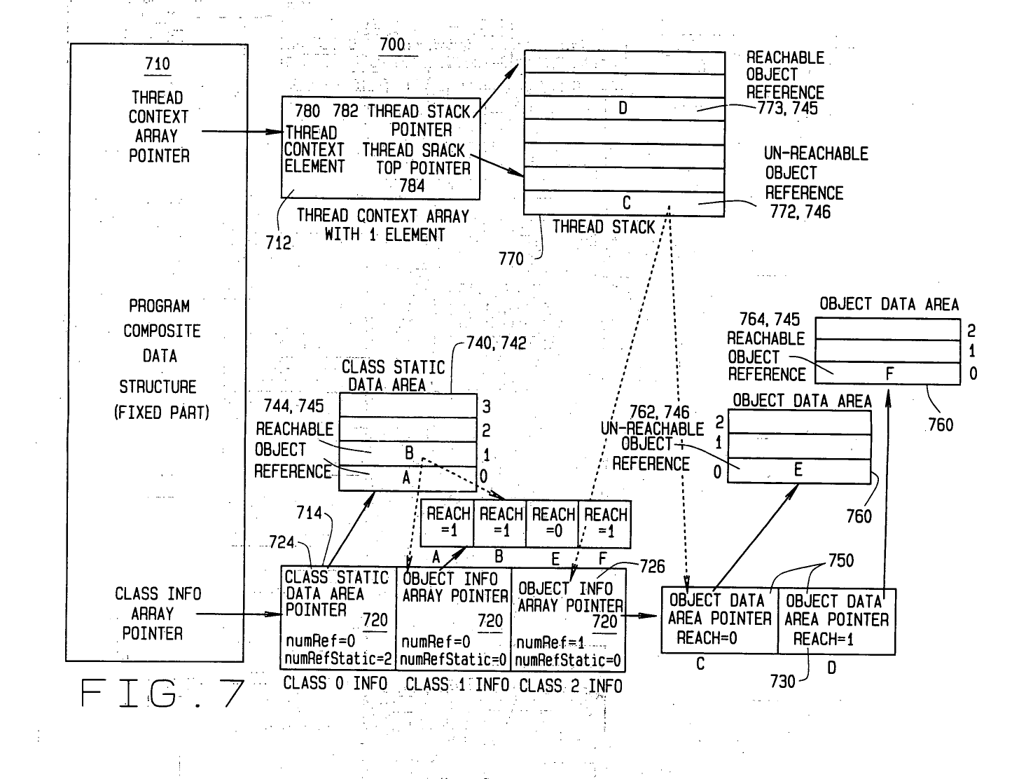

FIG. 7 illustrates a block diagram 700 of composite data structure components after the co-processor hardware logic is finished checking if a plurality of objects are accessible in a program during garbage collection, in accordance with one embodiment of the present invention.

The block diagram 700 includes a program composite data structure 710, a plurality of class info instances 720, a plurality of reach bit in each object info instance 730, a plurality of class static data (attributes) fields 740, a plurality of object data (class non-static attributes) area pointers 750, a pair of object data (class non-static attributes) areas 760, a thread stack 770 and corresponding thread context 780. The program composite data structure 710 includes a thread context array 712 and a class info array 714. Each class info instances 720 include a class static data area pointer 724, object info array pointer 726. Note that each of these elements is not shown in each class info instance for simplicity. Reachable object references 745 of program are shown. Un-reachable object references 746 are shown. The class static data area 740 include a plurality of class static data fields (attributes) 742 two of which are a reachable Object references 744. Only two object info instances 750 are shown to have pointers to object data area though every object info has a pointer of the type. The object info array pointer 726 is shown. The object data areas 760 include an unreachable object reference 762 and a reachable object reference 764. The thread stack 770 also includes an unreachable object reference 772 and a reachable object reference 773. The thread context 780 includes a thread stack pointer 782 and a thread stack top pointer 784 and is the only element of the thread context array 712. The object references which are static/non-static attributes of class (marked as A, B, E and F in figure) are shown to be resident starting at offset 0 in the class static data area 740 and object data areas 760. The co-processor garbage collection hardware logic is aware of this ‘well known’ protocol of native program (part of virtual machine) placing static/non-static object references at locations starting at offset 0 i.e. initial offsets are always object references (if any) and can find these object references by using the ‘numRef’ 727 and ‘numRefStatic’ 728 fields of class info instances 720. These fields ‘numRef’ 727 and ‘numRefStatic’ 728 populated by native program 410 notify hardware logic if object references are present in Object Data Area 760 and Class Static Data Area 740 respectively.

The object references present in program's thread stack (C and D) include programs class 0 static attributes (A and B) and class 2 object's non-static attributes (E and F). The dotted line denotes how indexes (class and object) are used to access the class info and object info instances associated with the object reference. For simplicity of figure only B and C references are shown to have the dotted lines. A, B, D and F are reachable, while C and E are not reachable. C is resident beyond the stack top and E is referenced through C. The object references are arranged at the start of class static and object's attributes. The ‘numRef’ and ‘numRefStatic’ fields in the class info instances informs the co-processor about the presence of object references in object data area and class's static data area respectively.

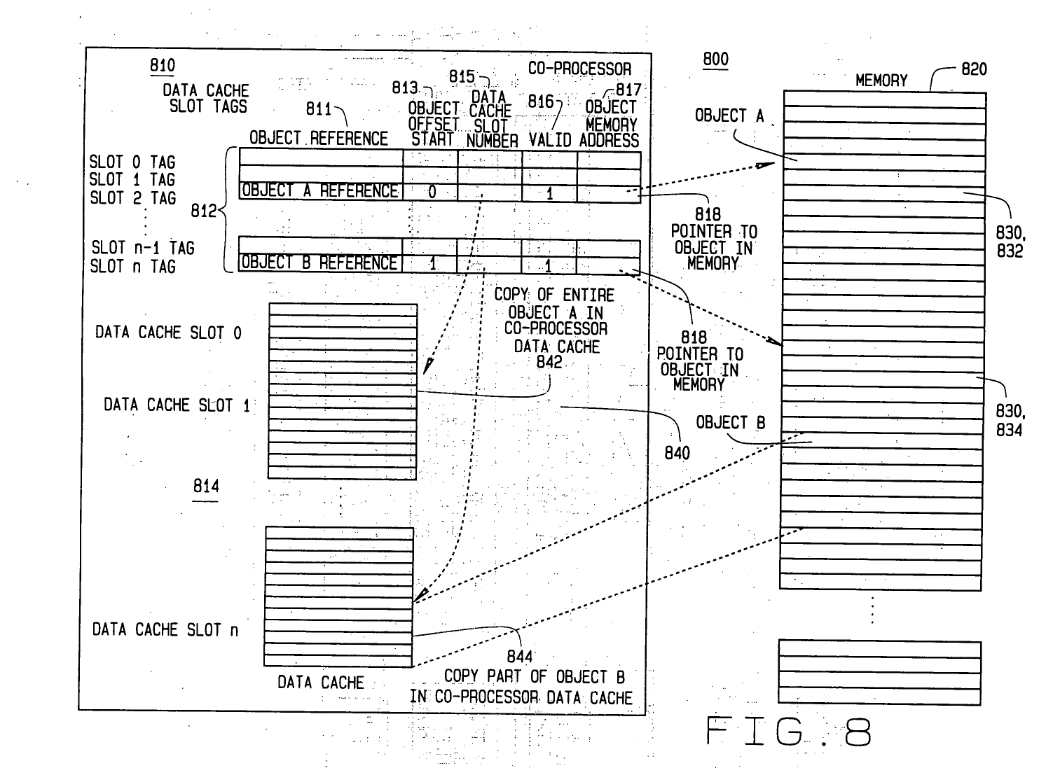

FIG. 8 illustrates a block diagram 800 of a data cache arrangement for executing a plurality of platform independent language programs by utilizing memory accessible by both a processor and a co-processor, in accordance with one embodiment of the present invention.

The block diagram 800 shows a co-processor 810, a memory 820, a pair of objects 830 and a data cache arrangement in co-processor 840. The data cache arrangement in co-processor 840 includes a plurality of data cache slot tags 812 and a plurality of data cache slots 814. Each of the data cache slot tags 812 include an object reference 811, an object offset start 813, a data cache memory address 815, a valid bit 816 and an object memory address 817. Cache slot tags 812 whose valid bit 816 is set will have a valid memory 820 address of object indicated by object reference 811 in its object memory address 817 field. The objects 830 include object A 832 and object B 834 which both reside in the memory 820. Copy of object A 842 and a copy of part of object B 844 are shown resident in slots of the data cache 840.

For ease of understanding, the individual components that come together to make the composite data structure, some of the said components are described using ‘C’ language structures. The native program which creates/modifies the composite data structure will be using these structures (or similar ones, in different embodiments) for its operation. It should be noted that the formats of these structures are known to the native method and co-processor hardware logic described in the system of the invention and hence the location of the attributes in these structures are termed as ‘well known locations’ in various descriptions in this invention.

‘C’ language ‘typedef’ conventions used are as follows
a. U32 is equivalent to 32 bit ‘unsigned int’.
b. U16 is equivalent to 16 bit ‘unsigned short’.
c. U8 is equivalent to 8 bit ‘unsigned char’.
d. Single or plurality of structure attributes that may be included in an actual implementation but not described in the system and method are denoted in the below structure definitions as
   ‘U32 computingPlatformSpecificData0;
   . . .
   . . .
   U32 computingPlatformSpecificDataN;’
      It may be noted that following formats are just for the purpose of describing the invention and actual implementation of an embodiment of the invention may choose a different suitable format.
1. Format of fixed part of the composite data structure 310:

```
struct CompositeDataStructure
{
    U32 programID; //System unique id of the Java program
    U32 threadCntxtArrPtr; //Memory address of thread context array
    U32 classDataArrPtr; //Memory address of class data array
    // Address in memory to the next composite data structure associated
    //with another Java program, in a multiprocessing environment.
    //The composite data structures are chained as a linked list to allow
    //the co-processor to select the next process to run thereby aiding
    //multi-processing without processor intervention.
    U32 compositeDataStrcutureNext;
    U16 threadIdx; // Index into Thread Context array, thread to execute
    U8 programState; //State of Program Running/Ready-To-Run/
    Blocked
    //Data specific to computing platform
    // (co-processor, hardware register snapshots, pointer to other
    //subsystem registers, etc.)
    U32 computingPlatformSpecificData0;
    ..........
    ..........
    U32 computingPlatformSpecificDataN;
};
```

2. Format of Thread Context 320. An array of this structure is present in every composite data structure. The number of instances of this structure is equal to the number of active threads in the object oriented platform independent program (e.g. Java program):

```
struct ThreadCntxt
{
    U32 stackPtr; //Address of base of thread stack in memory
    U32 stackTop; //Offset of active function stack top
    U32 localPtr; //Address in stack, local variables of active method
    U32 retInfoPtr; //Address in stack, return data (method return)
    //Structure below is used to hold information needed to boil
    //down to exact instruction of a method from where the thread should
    // start executing when it gets a chance to run again i.e. chosen
    // to be executed in a multithreaded program execution environment
    struct MethodInfo
    {
        U8 classIdx; //Index into class array whose method is of interest
        U8 methodIdx; //Index into method array of class (classIdx)
        U16 pc; //Offset to the next instruction to be executed in method
    }MethInfo;
    U32 timeSlice; //Time in ticks for which thread allowed to run
    uninterrupted
    U8 threadState; //State of thread Running/Ready-to-run/Blocked/Halt
    U32 computingPlatformSpecificData0;
    ..........
    ..........
    U32 computingPlatformSpecificDataN;};
```

3. Format of Class Information 360 structure. An array of this structure is present in the composite data structure. The number of instances of this structure in the array is equal to the number of classes loaded by the object platform independent language program. A ‘class index’ is used to index into this array e.g. Class Index that comprises the object reference:

```
struct ClassInfo
{
    U32 objInfoArrPtr; //Memory address of object-info array
    U32 classDataPtr; //Memory address of class static data
    U32 methArrayPtr; //Memory address of method-data array
    U32 numRef; //Number, non-static reference attributes declared in
    class
    U32 numRefStatic; //Number, static reference attributes declared in
    class
    U32 computingPlatformSpecificData0;
    ..........
    ..........
    U32 computingPlatformSpecificDataN;
};
```

4. Format of Object Info 370 structure. Array(s) of object info structure are present in the composite data structure. An instance of this structure exists corresponding to every object active in the object oriented platform independent program (e.g. Java program):

```
struct ObjectInfo
{
    U32 objectPtr; //Address in memory to the object data (attributes)
    U32 objectSz; //Size of the object data
    U32 objectMonitorCount; //Monitor associated with object
    U8 objectReachAble: 1; //Flag set if object is reachable
    U32 computingPlatformSpecificData0;
    ..........
    ..........
    U32 computingPlatformSpecificDataN;
};
```

5. Format of Method Data 350. Array(s) of this structure are present in the composite data structure. Methods (functions) of the object oriented platform independent program (e.g. Java program) is represented by this structure:

```
    struct MethodData
    {
        union{
            //Below struct (part of union) is relevant when the method
            //is implemented in class whose method array the
            //Method Data instance exists.
            struct
            {
                U32 MethNumLocals: 9; //Num local variables in
                method
                U32 MethNumParams: 6; //Num parameters in method
                U32 MethInstrInBytes: 13; //Num instructions
    //(opcode + operands)
                U32 Synch: 1; //Method is synchronized
                U32 MethNative: 1; //Native method
                U32 MethPrivate: 1; //Private method
                U32 MethImplInClass: 1; //Method implemented in
//class/parent-class
            } CurrentClassImplements
            //Below struct (part of union) is relevant when the method
            //is implemented //in a super class of the current class
            //whose method array the Method Data //instance exists.
            //The method may be however overridden in the current
            class also.
            struct
            {
                U32 pad: (32−10+1); // padding
                U32 ClassIdx: 10; //Index of class implementing
//method in class array
                U32 MethImplInClass: 1; //Method implemented in
//class/parent-class
            } SuperClassImplements;
            U32 value;
        } MethodAttr;
        U32 methInstPtr; // Instruction (byte code) address in memory
        U32 computingPlatformSpecificData0;
        ..........
        ..........
        U32 computingPlatformSpecificDataN;
    };
```

6. Format of Object Reference 560:

An instance of ‘ObjectRef’ can be used by native software or co-processor hardware logic to access the pointer to an object's attributes (fields). It can also be used to access the class information or the object information associated with the object.

```
    struct ObjectRef
    {
        U32 ClassIndex: 10; //Index into the programs class array
        U32 ObjInfoIndex: 22; //Index into the object array of the
//‘ClassIndex’ class
    };
```

Process/Task context data structure holding context information is maintained by software for each native process/task and is a well-known multitasking principal in computer science.

However the composite data structure of the present invention (similar to process context data structure popular in operating systems) is created by native software (running on a processor with an architecture) and is processed by a co-processor having a completely different architecture and instruction set (platform independent instructions) for the purpose of meeting the previously mentioned objectives.

Composite data structure includes;
a. Instructions not native to the processor that created the data structure.
b. Pointers and information to all dynamic data (objects) created during program execution.
c. Thread(s) context information (e.g. co-processor register snapshots) of each thread that constitute the program, needed by co-processor/native software. Each program has at-least one thread (the main thread) and can have un-predictable number of dynamically created threads at maximum.
d. Stack(s) of thread(s) that constitute the program.
e. Static data of all classes that have been loaded by program until now.
f. Pointers to programs (function) native to the processor.
g. Additional data pertaining to a specific embodiment (computing system specific data).
h. Information (attributes) of each method (function) of program.
i. Information of each class loaded by program.
j. Metadata, etc.

All the data listed above are arranged in the data structure 300 in a manner such that using just a pointer to fixed part of composite data structure 310 the co-processor can access all elements of the program (thread context, all objects of all classes loaded by program, static data of all classes, all thread stacks, computing system specific information, etc.) with minimal system clock cycles employing relatively simple hardware logic. The program elements are accessed by using operands (present in thread stack, instructions and co-processor registers) as ‘indexes’ and ‘offsets’ into the various composite data structure elements. These elements are generally arrays of structures or contiguous memory regions.

The composite data structure is created by (native software running on) a machine (processor with its own proprietary architecture and instruction set) to be accessed and utilized (for program execution) by another machine (co-processor) having a different architecture and instruction (platform independent language instructions) set.

Important characteristics of elements that make up the system of the invention
a. The co-processor appears (to the native software controlling the co-processor) similar to a DMA capable peripheral 110. This keeps the software model simple as compared to having two processors on a system. Such dual processor models need special operating systems, software dedicated for communication between two processors, separate software image for each processor, etc
b. As there is one composite data structure associated with each platform independent program executing in the computing system, multiple composite data structure are chained together like nodes of a linked list (see ‘compositeDataStrcutureNext’ attribute) when more than one program is executing in a multiprocessing environment 418.
c. More than one composite data: structures linked together are similar to a scatter-gather list accessed by DMA capable peripheral to do Input/Output. However the composite data structure is used to execute object oriented machine (platform) independent programs (Java, .NET, etc.).
d. A co-processor register 431 is programmed with the head of linked list of composite data structures, by native program of system. This allows for hardware logic to be implemented in the co-processor to select the next program to be executed, by ‘traversing’ the linked list of composite data structure 418. The co-processor does not need intervention from the processor (software) to choose the next program to schedule (execute).
e. Alternatively, the plurality of concurrently executing platform independent program composite data structures (fixed part) may be arranged as contiguous elements of an array.
f. As co-processor can access all the active programs, logic (programmable/non-programmable by software) may be implemented in the co-processor to select the next program based on policies like time-slicing, priority, etc. The policy to select the next program to execute is dependent on the co-processor implementation and does not fall within the scope of the present invention.
g. An alternative embodiment of the invention may be designed wherein a native program executing on the processor writes a pointer to a composite data structure into a pre-defined (well known) co-processor register 431 in order to indicate to a specific platform independent language program (corresponding to the said composite data structure) that needs to be executed by the co-processor. This can be used by the said native program to control scheduling of platform independent language programs in a multitasking environment.
h. With a pointer to just the first composite data structure 431,418 the co-processor can access all necessary elements (stack, objects, static class data, etc.) 300 of every (platform independent) program in the computing system and execute them in a multiprocessing environment. Usage of the arrangements listed in the invention to achieve co-processor hardware based acceleration of platform (machine) independent object oriented language programs like Java, .NET, etc. is a novelty in itself.

The method for object oriented platform or processor independent languages to operate by utilizing memory accessible by both a processor and a co-processor, in accordance with one embodiment of the present invention includes the steps of
a. loading of platform independent computer program by creating a composite data structure 300 corresponding to said program 440,
b. creating objects with attribute 370,390, byte code rewriting or modification 574,674, accessing the attributes of the created objects 500,
c. invocating methods using object references 600,
d. switching the context between different platform independent programs executing concurrently without intervention of software logic,
e. supporting garbage collecting process by marking un-reachable objects in a program 700 and
f. caching data 800 and instructions inside co-processor cache for quick access

The first step of the method to load a new platform independent program and the co-processor to execute the appropriate function of the program is described 900.

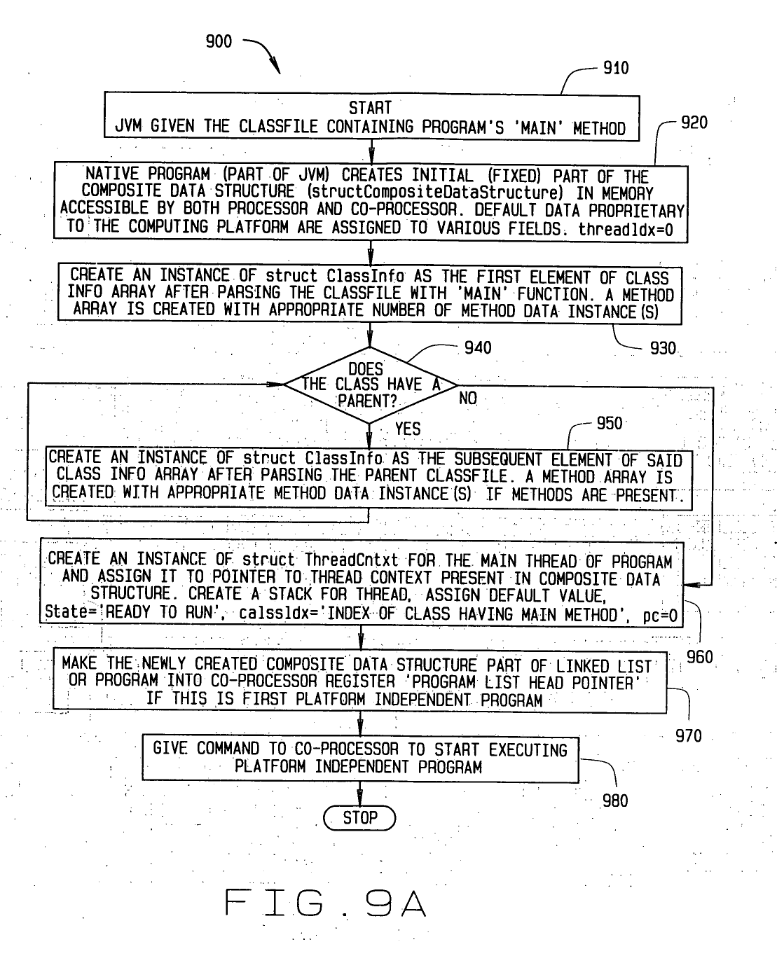

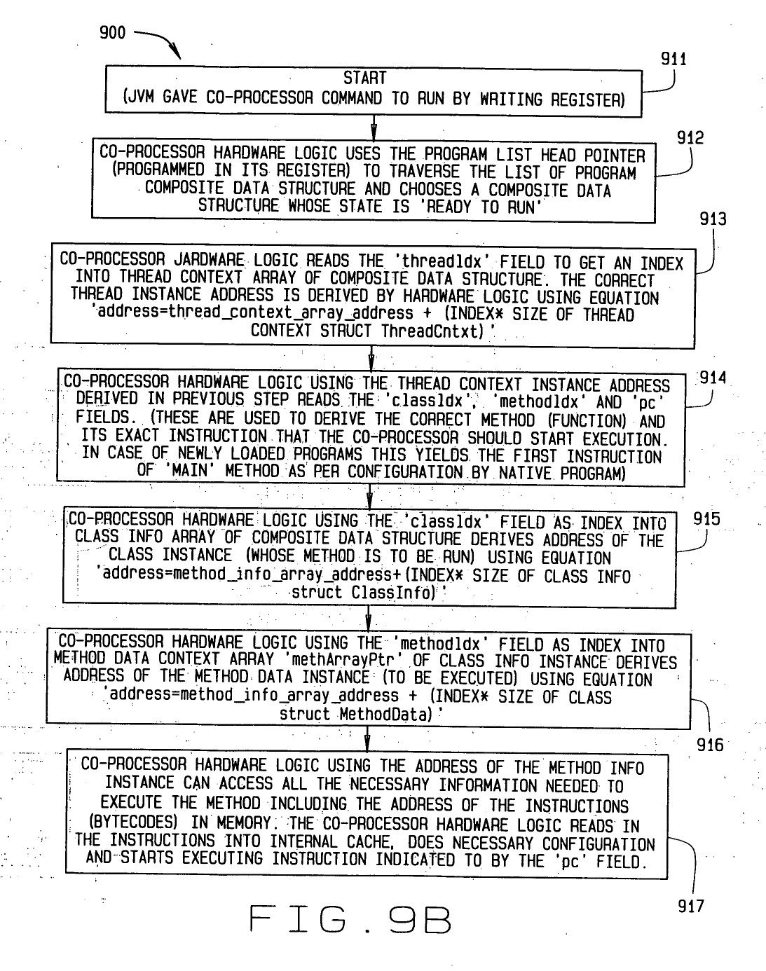

FIG. 9A describes a flowchart for the operation of the JVM (including said native program of invention) in loading a platform independent (Java) computer program and instructing the co-processor to start executing the said platform independent program such that main function is executed by co-processor. The JVM (the native program described is part of the JVM) upon start of a Java program is given path to the Java class file (say ‘Main.class’) which has the main method (function) of the program 910. The JVM creates initial (fixed) part of the composite data structure (struct CompositeDataStructure) in memory accessible by both processor and co-processor 920, 310. Amongst other things the following information are assigned appropriate values in the fixed part of data structure or its components.
a. Locations to store some co-processor registers snapshot and other (optional-proprietary) hardware registers of computing platform external to co-processor.
b. Pointer to arrays of structures like struct ThreadCntxt 312 and struct ClassInfo 314. These structures attributes confirm to data and format needed by various sub systems in co-processor hardware logic. Typical structures whose arrays are created are thread context (struct ThreadCntxt)—information like time slice, stack pointer registers snapshot necessary to manage context switch 321,322, 323, 324, class index whose method is being executed at time of preemption 325, method index at time of preemption 326, program counter (PC) in method opcodes 327, etc.
c. Class info (struct ClassInfo)instances created during course of program execution 362, 364. Information like index of parent class in the same class array, pointer to an array of objects 368, pointer to array of methods (functions) that a class owns 366, pointer to static data of class 361, etc.
   It is to be noted that in language technology like Java, the class initialization <clinit> methods (if any) are executed first. But for sake of simplicity and understanding the ‘main’ method is said to be executed first upon loading a program.
   Initialization of composite data structure components during program loading—data proprietary to the computing platform may be assigned to various fields of data structure for later use by both JVM/co-processor e.g. program unique id, etc. 920. The attribute ‘threadIdx’ used as an index into thread array indicates thread that was last executing i.e. when a program gets chance to run (selected by co-processor for execution) the index will be used to choose the program thread to run. The ‘threadIdx’ is set to 0 which is an index to access main thread context 920, 320.
   This is more of less initialization of the non-dynamic part of the composite data structure 310.
   The ‘main’ class file is parsed. A check is done if the class has a parent class 940. If yes, all the parent classes are also parsed 950. Say, the main class has just one parent class name ‘Parent’ in a class file named ‘Parent.class’. Thus two classes are loaded at program start (Parent and Main). Amongst other things the program has until now, allocated in memory a two element long array of ‘class info’ instances 360 and populated the pointer to this array to the ‘classDataArrPtr’ attribute 314. For each element of class info array, amongst other things, an array of ‘MethodData’ is created in memory if methods are present in class 930,950 and the pointer to the array is stored at the correct location 366 in the class structure instance confirming to the format of the class structure. The length of the array is equal to the number of methods present in the class. For each method instance amongst other things the pointer to instructions (opcodes and operands) 351, method attributes (private, synchronous, native, etc.) 353 are assigned. Memory (static attributes area) for the all static attributes of the class (if any) 380. Pointer to this static data storage area for the class is populated in the ‘classDataPtr’ field 361.

This is more or less creation of the dynamic part of the program until this point. The JVM allocates in memory a thread array of length 1 element (main thread of program) 960. The pointer to the array is then stored in the ‘threadCntxtArrPtr’ field 960. When the co-processor will start to execute the program it will read the ‘threadIdx’ field and use the value in the field as an index to choose the thread context from thread array ‘threadCntxtArrPtr’. At program start the value is made 0 by the software i.e. ‘main thread’ 920.

The ‘threadState’ is made ‘Ready-to-run’ 960. The index of the main method in the method array is populated into ‘methodIdx’ field of ‘main’ thread instance 960, 326. The index of the class containing the main method is populated into the ‘classIdx’ field of ‘main’ thread instance 960, 325. This causes the main function to get chosen by co-processor when the program is first run. As the ‘pc’ is initialized to 0 960 the first instruction in function (method) main will be executed by co-processor. After the composite data structure creation is done and all necessary information have been extracted from the class files (loaded until now) and arranged in the composite data structure confirming to the well-known format, the pointer to the base of the newly created composite data structure is made a part of the linked list of composite data structures 970, 418. The ‘compositeDataStrcutureNext’ 441 is made NULL.

The number of elements in this list is equal to the number of Java programs active in the computing system. Say, the Java program is the first to run on the system hence the linked list has only one element. The head pointer of the linked list (i.e. pointer to the program's composite data structure) is written into the co-processor register ‘Program List Head Pointer’ 970, 431. This ‘Program List Head Pointer’ register holds the head pointer to the linked list of active Java program's composite data structure list 418. The co-processor is given command to run by native software 410 by writing to a well-known ‘command register’ 980, 431.

FIG. 9B describes a flowchart for operation of co-processor after being given command to run executes the functions of platform independent programs 900. In case of composite data structures newly loaded by JVM (native program) the ‘main’ method (function) is executed.

The co-processor upon given the command to run by JVM 911 accesses the linked list of the active Java programs using the pointer value stored in the register ‘Program List Head Pointer’ 431. Based on a policy not falling in the scope of the invention a linked list element (platform independent program) with state ‘Ready to Run’ is chosen for execution 912. (Currently assuming there is only one Java program that was loaded by native program, so it is chosen). The co-processor accesses the composite data structure and from the fixed part of the composite data structure 310 reads the ‘threadIdx’ field 913 holding the index of the program thread that has to be run (the JVM has populated the index of main thread in this field). The co-processor then uses this index to access the correct thread instance 320 resident in the thread array pointed to by thread context array pointer 312 i.e. the main thread instance in case of newly loaded program. The pointer to thread array ‘threadCntxtArrPtr’ (populated by JVM) is used. A simple equation ‘address of thread array+(index of thread instance*thread instance size)’ is used to index into the correct thread instance 913. The address of the thread instance is derived.

Upon getting the address of the ‘main’ thread instance for newly loaded program, the co-processor fetches the ‘class index’, ‘method index’ and ‘program counter’ of the method that has to be run from the ‘classIdx’ 325, ‘methodIdx’ 326 and ‘pc’ 327 fields 914. At program start the combination of these will yield to the first instruction of the ‘main’ method 344 based on the values configured by the JVM during composite data structure creation (loading program). The co-processor uses the ‘class index’ to index into the composite data structure's class array 915, 315 and get the method array pointer ‘methArrayPtr’ 366 associated with the appropriate class 916. The co-processor then using the ‘method index’ indexes into the method array to derive the address of the correct method instance 350, 916. The equation used is Address_of_method_array+(index_of_method*method_instance_size) 916. Once the method instance is acquired all method related information (method attributes) 353 and pointer to method instructions 351 can be acquired by co-processor from the external memory 412, 917. The instructions are then read into one or more slots of a method cache. The ‘program counter’ (which is 0 as this is program start) is used as an offset into the instructions from which execution is to begin 917. Thus the main function starts to execute.

The second step of the method described is creating objects with attributes, byte code rewriting or modification 574 and accessing the attributes of the object 596, 1000. Assume after the loading of a platform independent (Java) computer program, a main function having the following instructions are executed by co-processor hardware logic 570

NEW 00 01//Create an object and push the reference to the object to stack

ICONST_4//Push a value 4 to stack

PUTFIELD 00 03//Push data on stack top i.e. 4 into the object field (attribute)

For the co-processor to access (write) the stack top data 552 to the object field 542 it may be necessary that the co-processor 430 hardware logic may have to derive the address in memory 412 where the object's fields are located. The points below describe the steps as to how the co-processor is able to obtain the said address during program execution. The native software (virtual machine) 410 creates the composite data structure and does the necessary initializations so that the main function instruction is accessed and executed by co-processor.

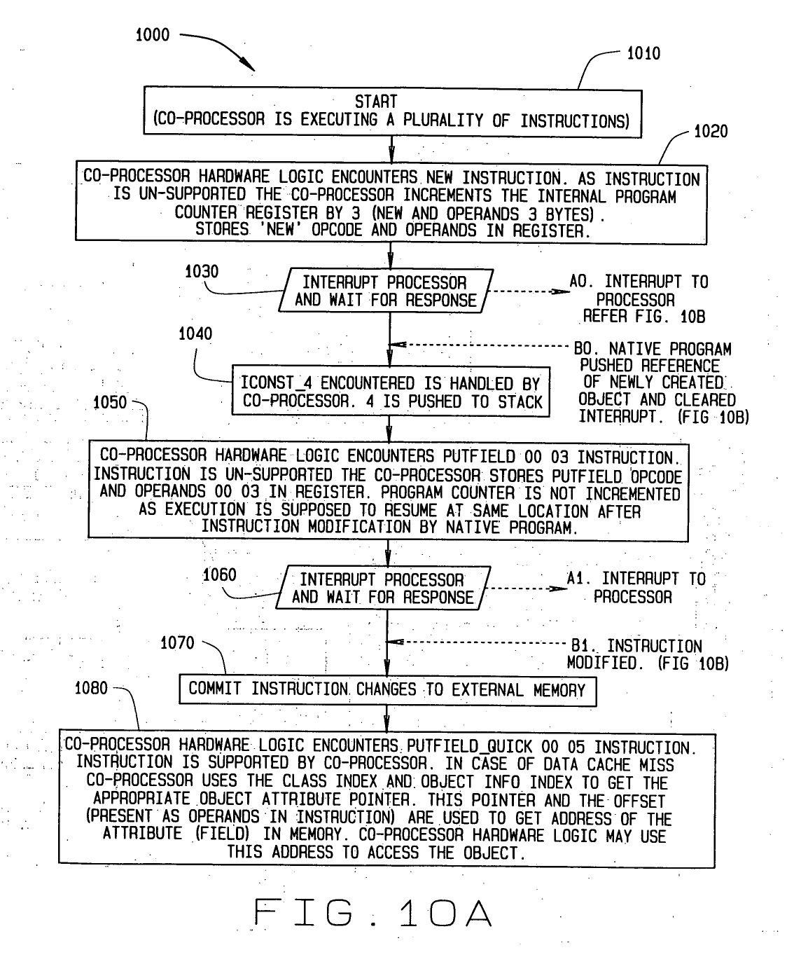

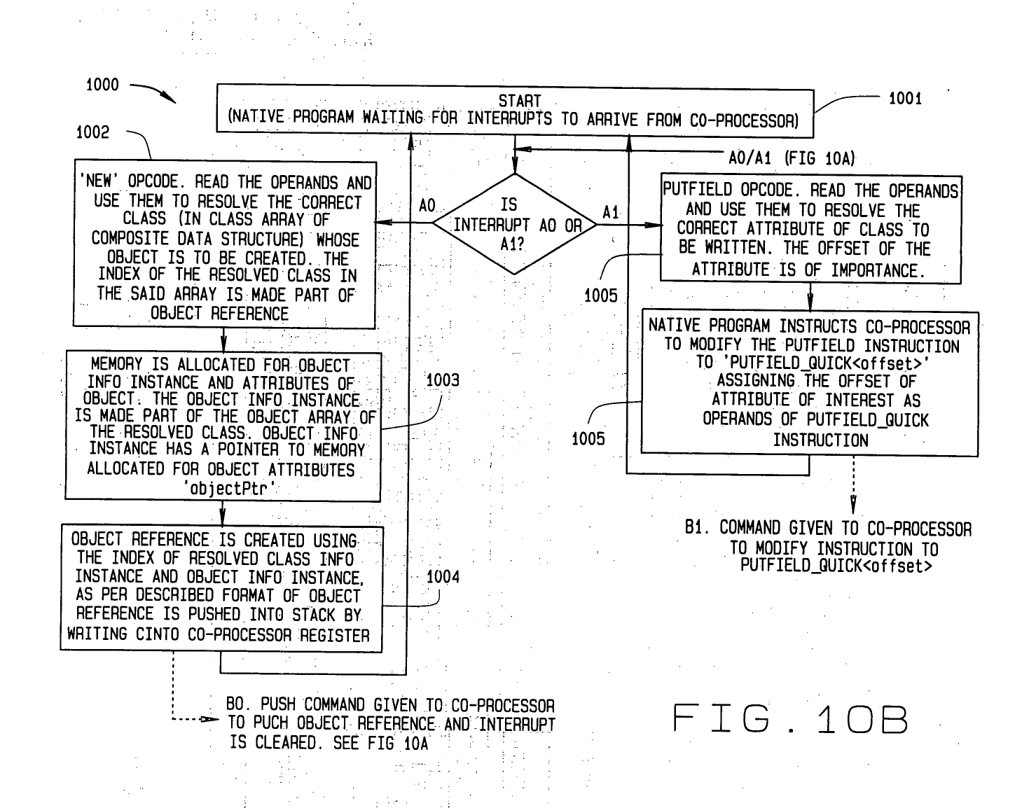

FIG. 10A (existing in conjunction with 10B) is a flow chart describing the operation of the co-processor's hardware logic, while executing above mentioned instructions involving creating of an object and accessing its attribute.

FIG. 10B (existing in conjunction with 10A) is a flow chart describing the operation of the native program interrupt handler, while executing above mentioned instructions involving creating of an, object and accessing its attribute.
a. The co-processor starts executing instructions of a function (method) 1010, 570.
b. The co-processor executes the first instruction ‘NEW 00 01’. As the NEW instruction is not supported in hardware, the co-processor increments the program counter by 3 bytes to point to next instruction. The NEW opcode and operands ‘00 01’ and other information necessary are stored in co-processor 430 registers to be read by the native program 410 during interrupt handling 1020. Co-processor interrupts the processor 164, 1030.
c. In the interrupt context, the native software (virtual machine) 410 uses the operands ‘00 01’ to index into the virtual machine's constant pool to resolve the correct class whose object is to be created 1002. Say, the class info instance of class whose object is to be created is at index 1 of the program's class array pointed to by ‘classDataArrPtr’ 314.
d. After this the native program allocates an ‘Object Info’ structure instance 370 and a chunk of memory 390 to store object attributes (non-static or per instance attributes of class) in memory 1003. Say, the ‘Object Info’ structure instance is the first instance of the object array pointed to by ‘objInfoArrPtr’ 368 present in the class instance (index 1) and therefore has an index 0. The object data pointer 376 is populated with the pointer to the chunk of memory 390 allocated for the object attributes 1003.
e. The index of the resolved class ‘1’ and the index of allocated ‘Object Info’ instance ‘0’ are together used to create a reference to the object adhering to the format of the ‘struct ObjectRef’ 1004, 560. The reference is then pushed to the top of the current thread stack (main thread) 554. The pushing is accomplished by writing the object reference to a co-processor register 1004. This causes the co-processor to resume executing the instructions after interrupt is cleared.
f. Co-processor then executes the next instruction ‘ICONST_4’. As the instruction is supported by the hardware logic the co-processor pushes a value ‘4’ 562 to the top of the currently executing thread stack 550.
g. Co-processor then executes the next instruction ‘PUTFIELD 00 03’ 576, 1050. This instruction is used to write the data present at stack top 552 into an objects field. Note that the program counter is not incremented as the co-processor will execute the instruction again after rewriting (modification) of the byte codes (instruction) with ‘quick’ variant of the instruction by the native software 1050. The operands ‘00 03’ and other information necessary are stored in co-processor's 430 registers to be read by the native program 410 during interrupt handling 1050.
h. The co-processor interrupts the processor 164, 1060.
i. In the interrupt context the native software (virtual machine) 410 indexes into the constant pool of the virtual machine using the operands ‘00 03’ to resolve the exact field of the class that needs to be written data 1005.
j. Upon resolution the native software changes the instruction from ‘PUTFIELD 00 03’ to say ‘PUTFIELD_UICK 00 05’ 574 by writing into co-processor register 1006. Here the new operands ‘00 05’ 578 is the offset of the field (attribute) of interest, in object attributes memory.
k. The co-processor resumes operation and commits the changed instruction and operands to external memory 1070. With a pointer to the object's attributes memory (objectPtr) 532 co-processor may access the field in memory by adding the pointer with the said offset 578, 1080. The ‘PUTFIELD_QUICK’ is supported by the co-processor hardware logic. Henceforth if the instruction at the changed location is executed (in a loop or upon next invocation of function) again the co-processor will be able to handle the instruction without the need to interrupt processor.
l. Co-processor executes ‘PUTFIELD_QUICK 00 05’ (as program counter was not incremented). In case of data cache miss the co-processor hardware logic needs to resolve the address of the object in external memory 1080 and access the memory using the address 162. To: resolve the address of the correct part of the object that need to be loaded into data cache, the co-processor makes use of the following elements.

a. Object reference from stack 554—The class index 562 and object index 564 from the object reference is used to index into the programs class array and the'class's object array respectively. This, yields the object info instance 530 of the appropriate object. The ‘objectPtr’ present in the object info instance gives the pointer to the objects attributes memory.

b. Operands of the PUTFIELD_QUICK instruction—The operands ‘00 05’ is used as an offset. ‘objectPtr+5’ will yield the location of the field as all the fields are of same size (say 32 bit/4 bytes). Using this address the correct part of object is read into data cache slot 814 by co-processor memory access logic 1080.

c. Value to be populated from stack top—The value to be populated (4 in this case) is pop-ed from stack and written to the cache memory location corresponding with object attribute of offset 5 814.

The third step of the method described is invocating the method 1100. This chapter describes how the various components of the invention and their arrangement 300, 400 are used to invoke a method during program execution. Assume the loading of a platform independent (Java) computer program, a main function executed by co-processor having the following instructions 670.

NEW 00 01//Create an object and push the reference to the object to stack

ICONST_4//Push a value 4 to stack

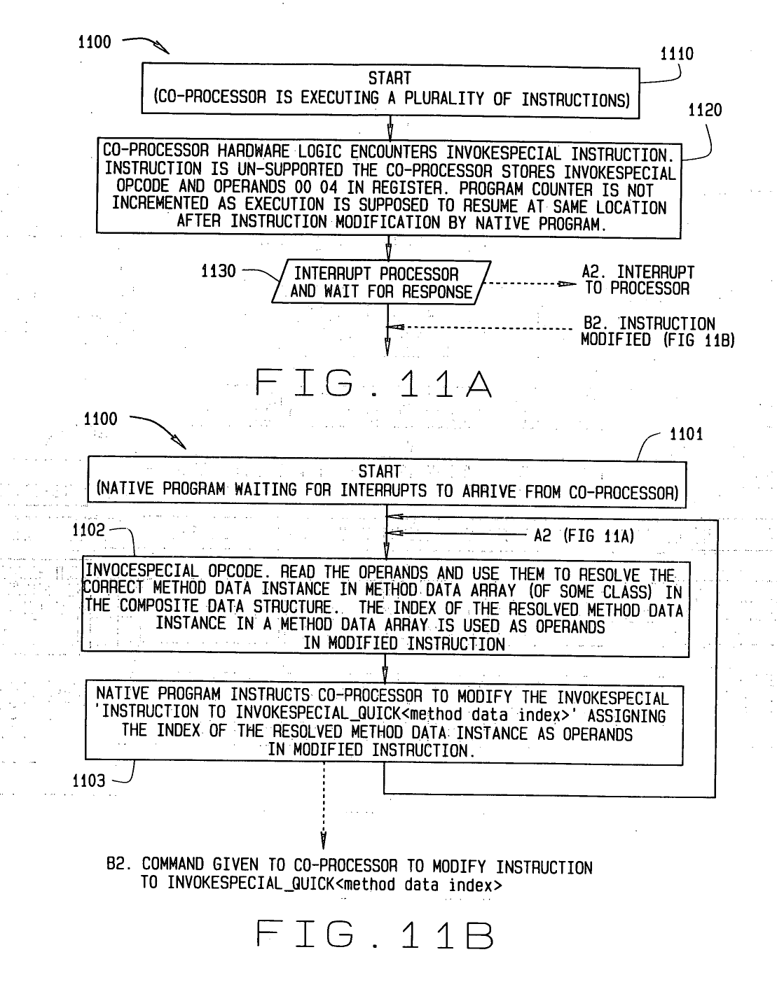

INVOKESPECIAL 00 04//Invoke the class's constructor method FIG. 11A (existing in conjunction with 11B) is a flow chart describing the operation of the co-processor, while executing above mentioned instructions involving invoking a non-static function using an object reference.

FIG. 11B (existing in conjunction with 11A) is a flow chart describing the operation of the native program interrupt handler, while executing above mentioned instructions involving invoking a non-static function using an object reference.

For the co-processor to invoke the method it is imperative that the co-processor gets the method's attributes (number of method parameters, number of instructions in method, method implemented by this class, etc.) 353, pointer to method's instructions in memory 351, etc. In short it may have to access the memory 412 location where the ‘method data’ instance 350 of the method is resident. The execution of NEW and ICONST_4 instructions is already described, byte code rewriting or modification and accessing the attribute of the object step and will not be repeated for the sake of brevity. The execution of these instructions 672 will cause the object reference and a value of 4 to be pushed to the stack 652.
a. Co-processor 430 hardware logic executes the instruction ‘INVOKESPECIAL 00 04’ 673, 1120. Say, this instruction is used to invoke the class's constructor method. As this instruction is un-supported (quick variant supported after byte code rewriting) by the hardware logic the co-processor needs intervention of native program 410, 1120. Note that the program counter is not incremented as the co-processor will execute the instruction again after rewriting (changing) of the byte codes (instruction) by the native software. The operands ‘00 04’ and other information necessary are stored in co-processor registers to be read by the native program 410 during interrupt handling 1120.
b. The co-processor interrupts the processor 164, 1130.
c. In the interrupt context, the native software (virtual machine) derives operands from co-processor register and uses the operands ‘00 04’ to index into the constant pool to resolve the correct method to be invoked 1102. Say, the index of the resolved ‘method data’ instance is 2 in the method data array 632 of the class to which the method belongs.
d. The native software then commands the co-processor to modify the instruction replacing the ‘INVOKESPECIAL 00 04’ with ‘INVOKESPECIAL_QUICK 00 02’ 675 by writing into co-processor register 1103. The operands ‘00 02’ corresponds with the index of the method data instance in the method data array 632. After this the co-processor resumes to continue executing instructions as interrupt is cleared.
e. Co-processor executes ‘INVOKESPECIAL_QUICK 00 02’ (as program counter was not incremented). To execute ‘INVOKESPECIAL_QUICK’ the co-processor makes use of the following elements.

a. Object reference from stack 654—The class index 662 of the object reference is used to index into the program's class array 612. This yields the ‘class info’ instance of the class, the object of which is used to invoke the method. The ‘methArrayPtr’ present in the class info instance can be used now to access the ‘method data’ instance.

b. Operands of the INVOKESPECIAL_QUICK instruction—The operands ‘00 02’ serve as an index into the method data array to get the ‘method data’ instance.

The method data holds the following information that the co-processor uses to invoke the method

a. Method attributes 353—Information like number of parameters (MethNumParams), number of locals (MethNumLocals), etc. are used to adjust the various pointers to the stack (internal to co-processor) to invoke the method. Information like ‘MethPrivate’ and ‘Synch’ are used for access checking and managing concurrency respectively. The attribute. ‘MethImplInClass’ helps co-processor to locate the exact method data instance in case the current class does not implement the method (a parent implements the method).

b. Pointer to Instructions 351—The ‘methInstPtr’ attribute is a pointer to the instructions to the method to be invoked. Using this the co-processor accesses the instructions to be executed.

The fourth step of the method is switching the context between platform independent programs active in the system 440 with the co-processor requiring no intervention by software logic executing on processor 420. For the co-processor's hardware logic to bring about a context switch it is necessary that all the context information of a program 440 are available to it and is accessible in minimum clock cycles using a relatively simple hardware logic. The co-processor executes a program (say Java program) 442 until a point when the need arises for the co-processor to context switch to execute another program. This is necessary in a multi-processing environment where more than one program share the computing resources to execute concurrently. The reason to switch context may vary from the lack of available resources (object's monitor cannot be entered) or program's timeSlice is over or higher priority program is ready to run. The policy using which the co-processor context switch programs does not fall in the scope of this invention. The policy may be hardwired or programmable in the co-processor 430.

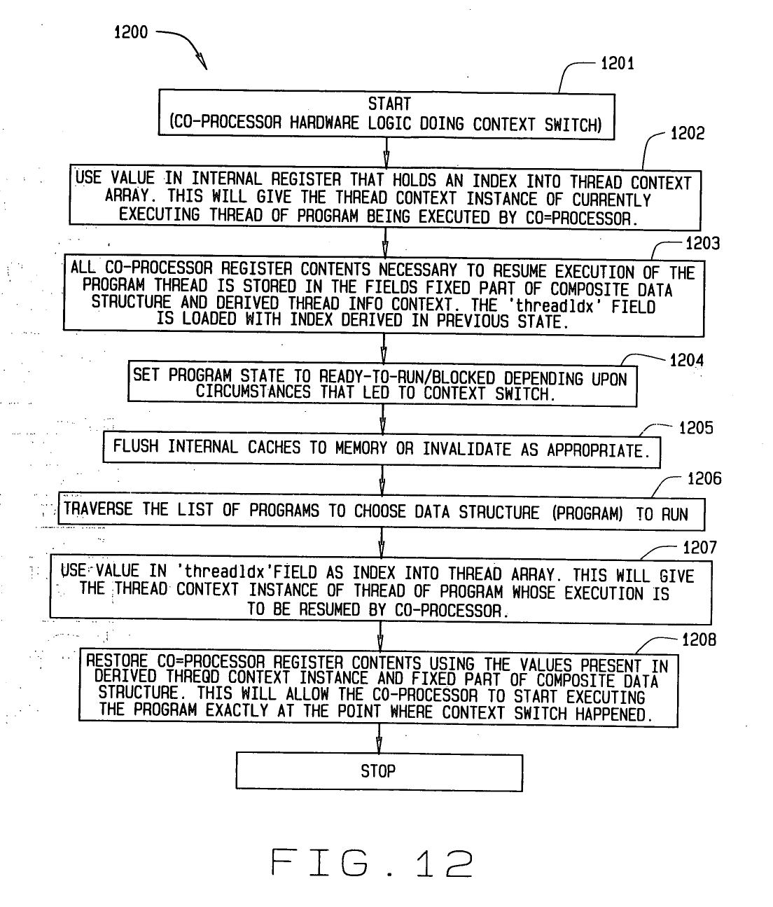

FIG. 12 is, a flowchart describing the flow of operation of the co-processor during the process of context switching between two platform independent programs without intervention from processor.

At the time of program context switch the co-processor does the following:

a. For the program's thread that was currently being executed the co-processor hardware logic accesses the ‘Thread Context’ instance 320 by indexing into the array pointed by ‘threadCntxtArrPtr’ 312, 1202. The index is derived from a co-processor register used to hold index of currently executing thread of currently running program.

b. Upon getting the correct thread context instance the co-processor stores all the information from its internal register into the thread context instance and into attributes of fixed part of composite data structure 310 as appropriate 1203. This information includes the various pointers to thread stack, information related to the method that was being executed when the context switch took place ‘MethInfo’ are stored in appropriate attributes of thread context instance 325, 326, 327. The index of the thread that was executing is stored in ‘threadIdx’ field of fixed part of composite data structure 1203.

c. Storing of the information allows the Program to resume at the exact point where it was context switched.

d. The state of the program and it's thread that was executing is set to Read-To-Run/Blocked depending upon what exactly caused the program to be context switched 1204.

e. All internal caches 840 are flushed (written) to memory or invalidated as appropriate 1205.

f. After this co-processor traverses the list of composite data structure 418 in order to choose the next program to execute 1206.

g. Upon choosing the next program to execute i.e. associated composite data structure 443, the co-processor reads the ‘threadIdx’ field to derive index into thread context array 1207. Co-processor updates its internal registers with the context information from thread context instance 320 and other parts of the newly selected composite data structure derived by using the said index such that the program execution can start exactly where it was interrupted 1208.

The state of the program and its thread is made RUNNING.

The fifth step of the method described is co-processor supporting garbage collection by marking only reachable objects 745 in a program. This describes how the various components of the invention and their arrangement allow the co-processor hardware logic to detect objects that cannot be reached 746 in a program. These objects can then be garbage collected i.e. their memory freed. In an active program object references may be resident in thread stack(s) 770, class static fields 740 and object attributes 760. The challenge for any algorithm to detect an object reference is the fact that all the places where object references may be resident also hold primitive data and program information (stack).
a. The native software (virtual machine) 410 assigns offsets to all the static attributes 382 and non-static attributes (fields) 392 in a class. The static attributes are resident in class's static data area 380 while copies of non-static attributes are present in the each object's data area 390. The native software arranges all the attributes which are object references 560 in the initial part of the class's static data area 380 and object attributes area 390, followed by primitive (int, char, float, etc.) attributes. Thus the object references (if present) have offsets starting from 0 to ‘n-1’, where n is number of object references present. For more understanding of offsets of attributes see chapter on accessing attributes (field).
b. The native software assigns ‘numRef’ 727 and ‘numRefStatic’ 728 fields of ‘Class Info’ instances with the number of non-static and static object references respectively declared in the class. For example, if there are 2 non-static and 3 static object references present in a class. Upon loading the class, the ‘numRef’ field of the class info instance will be assigned a value of 2 and the ‘numRefStatic’ is assigned a value 3. The co-processor 430 hardware logic is aware of this ‘well known’ fact and reads these attributes during garbage collection.
c. At the time of garbage collection of a program, the native software provides the co-processor the pointer to the program's composite data structure 440 and writes a command to start checking the reach-ability of the allocated objects in the program.
d. The co-processor traverses the array of thread context 712 in the program and for each thread context traverses the thread stack 770 looking for object references, beginning at the start of the stack 782 and continuing till the stack top 784. The algorithm to differentiate between an object reference and primitive data in the stack does not fall within the scope of this invention. It is assumed that logic exists for the co-processor to determine whether a data present in stack is an object reference or not.
e. For each object reference the co-processor comes across,
   i. The co-processor using the class info and, object info indexes (that constitute the object reference) accesses: the ‘objectReachAble’ field 757. If the value is already set (i.e. 1) the co-processor-moves on to search for the next object reference.
   ii. If the ‘objectReachAble’ field is found to be reset (i.e. 0) the co-processor logic infers that the object is accessed for the first time (in current garbage collection cycle).
   iii. Using the class info index the co-processor accesses the ‘numRef’ field. The value stored in this field is used by the co-processor to determine if objects of the class have references in their fields.
   iv. If the number of references is non-zero (say ‘n’), the co-processor is aware that the first ‘n’ numbers of data in the object's data area 764 are object references 760. For each of the object references present 0 the object's data area the steps in this point (e) are performed.
   v. After the co-processor is done processing all the object references present in an object's data area it sets the ‘objectReachAble’ bit to 1, denoting that the object is reachable in the current program and has been accessed in the current garbage collection cycle.
f. After finishing traversing all the thread contexts 780 of the program and processing all the object references 774 encountered in the stack(s) 770 the co-processor starts traversing all the class info instances in the program's class info array 714.
g. For each, class info instance the field ‘numRefStatic’ 728 denotes the number of object references in the class's static data area 740. If the number of object references is non-zero (say ‘n’), the co-processor is aware that the first ‘n’ numbers of data in the class's static'data area 740 are object references 744. For each object references found (as per point g above) the steps in point e above are executed.
h. Upon completion of traversal of the entire class: info contexts of the program, all the objects that are reachable in the program have the ‘objectReachAble’ bit set to 1. The co-processor interrupts the processor signaling the completion of checking object reach-ability.
i. The native software (virtual machine) upon receiving an interrupt from co-processor traverses all the objects info instances checking the ‘objectReachAble’ bit. If the bit is set the native software resets the same. If the bit is reset indicating that the object is not reachable in the program the native software may de-allocate the memory occupied by the object's object info instance and object's data area.

The sixth step of the method described is caching implemented by the co-processor 430 to quickly look-up necessary information. The step describes how the various components of the invention and their arrangement allow the co-processor to implement caches (instruction, data and thread stack) that can be used to lookup necessary information during program execution without the need for the co-processor to access external memory. This reduces the co-processor's external memory access thereby increasing the speed of program execution and reduces the load on system bus. In this description the data cache is described. The method cache (holding information and instructions of frequently invoked method) also has a similar principal of operation as data cache.

As previously described in the second step of the method, the class index 562 and object index 564 (both available in object reference) and the modified (bytecode rewriting) operands and instructions like PUTFIELD_QUICK and GETFIELD_QUICK are used to access the fields of objects 542. The co-processor implements amongst other caches, a data cache where it stores the objects that were recently accessed. The co-processor data cache 840 stores, information like slot number of internal data cache 815 and external memory 820 in order to do various operations like field read, write, flushing to memory, etc.

FIG. 8 shows a cache arrangement which can be used to lookup the location of an object inside the data cache and in external memory by co-processor hardware logic. The co-processor hardware logic at the time of accessing object's fields resolves the exact location in memory by using the object reference from the stack and operands of the PUTFIELD_QUICK and GETFIELD_QUICK instructions (this is offset of field). The co-processor at the time of execution of PUTFIELD_QUICK, GETFIELD_QUICK type of instructions first looks up the internal data cache tags 812 using the combination of object reference 554, 811 and the offset 578, 813, to see if the object (or relevant part of object) whose field is being accessed is cached in a data cache slot 814 internal to co-processor. If the object 830 (or relevant part of object) is not cached the object (or relevant part of object) is first read into a data cache slot 814, 842, 844 and the corresponding tag 812 associated with the slot is updated with the following data:

a. Object Reference 560—The object reference used to execute the instruction 554. This along with ‘Offset’ 578 is used to lookup the tags 812 to check a cache hit.

b. Offset—The offset 578 (MSBs are updated depending upon cache slot size e.g. for a 32 cache slot size the lower 5 bits are masked) of the field being accessed. This along with ‘Object Reference’ 554 is used to lookup the tags to check a cache hit.

c. Data Cache Slot Number 815—Slot 814 (data cache slot id) where the copy of object (or relevant part of object) is resident. During a cache hit a sum of this address and the offset 578 is used to resolve the exact location in data cache that has to be accessed (read/written).

d. Valid 816—A single bit value if set denoted that the data in the tag is valid and can be used by the co-processor hardware logic to check a cache hit/miss. This bit is reset when the co-processor switches from one Java program to another causing invalidation of cache.

e. Object Memory Address 817—The address of the object in the memory 412. This is read by the co-processor from the ‘objectPtr’ 532 field when the object is accessed upon a cache miss. This value is used by co-processor when the object (or part of object resident in cache) is written back (flushed) to external memory 820.

It should be noted that if the object size is greater than the data cache slot 814 size (line size) the relevant part of the object based on the field offset being accessed is read into the data cache. The ‘Offset’ field 813 of the tag is therefore used in conjunction with the ‘Object Reference’ 811 by the co-processor to determine if the necessary part of the object is cached. For example, if the cache slot size is 32 and a field of a given object (size is greater than cache slot size) at offset 34 is accessed the ‘Offset’ field of the tag is made ‘1’ and the part of the object starting from offset 32 is cached in (5 LSBs are masked).

Next during the course of program if a field of the said object at offset 3 is to be accessed the offset used for comparison is 0 (as the 5 LSBs are masked out). As a tag holds the value ‘1’ for the given object reference there is a ‘cache miss’. Arrays and static attributes of classes are also cached in data cache in the same manner. In case of class static attributes (class static data) the object info index part holds a value of 0. The Class info index part holds the class index whose fields are being accessed. In case of Arrays the class info index part holds a value of ‘0’ while the object info part holds relevant data.
Thus, the present invention apart from executing the instructions fast also provides support to implement mechanisms (features) like:
a. Garbage collection (memory management)—As pointer to each dynamic data (objects) and thread stack, created in the course of program execution is present in the composite data structure is accessible by co-processor, it becomes possible to implement hardware logic inside co-processor to analyze which of the objects are unreachable. This can help ‘mark’ these objects for garbage collection without intervention by processor.
b. Thread/Process scheduling services to select the next thread to run and do all the necessary operations like swapping internal register contents, flushing internal caches (program, data, stack, etc.) without intervention by processor.
c. The system and method of this invention allows the virtual machine (executing on the processor) to change location of the dynamic data (objects) and other components of the composite data structure (methods, thread context array, static data of individual classes, etc.) in the memory (during course of program execution) in order to address memory management issues like memory fragmentation: Compacting garbage collectors which move related objects close to each other are also known to change the location of objects.
d. The system and method of the invention allows the implementation of data, method (program) and stack caches internal to the co-processor that allows the co-processor to obtain information necessary for program execution (method attributes, pointer to instructions, pointer to object data, etc.) without the need to access the composite data structure resident in memory. This speeds up program execution.
e. The composite data structure format is not influenced by the format of the executable files (.class, .jar, .dex, etc.) for a given language technology. Therefore single co-processor hardware logic can execute programs from different flavor of a language (say Java) as long as the native software can parse the executable files and reduce them to the format of the composite data structures. E.g. the co-processor can drive classic Java (.class/.jar files) and Android Java (.dex files) programs as long as there is native software which reduces each type of the executable files to composite data structure format.
   As the executable files of a platform independent language program are reduced to an intermediate composite data structure format that co-processor understands, using suitable software (running on processor) an embodiment of the invention can be implemented wherein different platform independent language programs (say Java and .NET) can be executed by same hardware logic of co-processor.

### ALTERNATE EMBODIMENTS

1. An embodiment of the present invention may use a non-volatile memory. e.g. EEPROM or ROM instead of RAM as the memory 412 described in the system. The composite data structure(s) 300, 440 of the system in the embodiment will be created by a computer program executing on an external computer and not by native program 410 as described in system of invention. The composite data structure(s) thus created will be burned into the non-volatile memory for access and processing by the hardware logic of the co-processor. Such an embodiment will be possibly implemented in Java smart cards systems where the programs to be executed are fixed and burned into non-volatile memory. Such an embodiment will take advantage of a reduced time overhead of execution start time. Also the size of the native program 410 will drastically reduce as the software logic to create the composite data structure is offloaded to the external computer program.
2. An embodiment of present invention may implement the memory 412 described in the system inside the co-processor 430 described in the system.
3. An embodiment of present invention may have the memory 412 described in the system distributed as a non-contiguous chunks of physically separate memory i.e. the memory may be distributed across on-chip and off-chip physical memory. On the other hand the memory may be distributed across on-board and on-card (PCIe card) memory.
4. An embodiment of the present invention may include the hardware logic of the co-processor inside a more complex co-processor (say graphics co-processor) to build a innovative peripheral which can natively execute object oriented platform independent programs e.g. Java programs. Many graphics user interface programs, games, etc are written in Java programming language. A complex graphics peripherals which can execute the games/GUI applications internally and speed up access of its video memory by the program logic can be developed and can add tremendous value.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

1. A system for concurrent execution of a plurality of computer programs belonging to an object oriented platform independent language technology, comprising:
a processor;
a co-processor including a hardware logic, a plurality of registers and said hardware logic capable of executing a plurality of machine independent instructions of said object oriented platform independent language technology;
memory consisting of a plurality of memory locations, that is read and write accessible by said processor and said co-processor;
a bus interface that facilitates interfacing of said memory, said co-processor and said processor wherein said co-processor and said processor can perform read and write access to said memory;
a plurality of composite data structures with a format, residing on said memory, created by parsing a plurality of executable files; and
a native program executed by said processor,
whereby said hardware logic can fetch a plurality of instructions and data belonging to said plurality of computer programs, from said memory, thus reducing dependency on said processor.

2. The system according to claim 1, wherein said processor is a general purpose processor.

3. The system according to claim 1, wherein said processor is a digital signal processor.

4. The system according to claim 1, wherein said processor is a micro controller.

5. The system according to claim 1, wherein said processor, said co-processor, and said memory reside on a single chip.

6. The system according to claim 5, wherein said memory can be exterior to said single chip.

7. The system according to claim 1, wherein said processor, said co-processor, said memory and said bus interface reside on a single computer board.

8. The system according to claim 1, wherein said co-processor resides on a card attachable to a computer board and used after said card is attached to said computer board.

9. The system according to claim 8, wherein said card is a PCIe card.

10. The system according to claim 1, wherein said bus interface is physically or logically in communication with said processor, said co-processor and said memory, whereby said processor reads and writes said co-processor registers.

11. The system according to claim 10, wherein said processor and said co-processor can perform read and write access to said memory.

12. The system according to claim 1, wherein said hardware logic is included in a complex co-processor which performs other operations apart from native executing processor independent instructions of said object oriented platform independent language technology,
whereby complex co-processors like a graphics co-processor can be used to execute graphic user interface applications developed using languages like Java, .NET, etc.

13. The system according to claim 1, wherein said plurality of composite data structures are a logical representation of said plurality of computer programs, such that each composite data structure of said plurality of composite data structures corresponds to a computer program of said plurality of computer programs,
whereby said hardware logic can access said plurality of composite data structures to concurrently execute said plurality of computer programs.

14. The system according to claim 13, wherein said composite data structure comprises:
a) one or more thread context information;
b) one or more thread stacks, each associated with said thread context information;
c) a plurality of method information each comprising of information pertaining to a corresponding method and pointer to instructions of said corresponding method;
d) a plurality of initialized data;
e) a plurality of object information each corresponding to an object of said computer program; and
f) a plurality of class information each corresponding to a loaded class of said computer program;
whereby said computer program is reduced to a simple format, which can now be processed by said hardware logic efficiently.

15. The system according to claim 14, wherein said composite data structure is created by said native program executing on said processor but processed by said hardware logic such that both said native program and said hardware logic are aware of the format of said composite data structure.

16. The system according to claim 15, wherein said hardware logic executes Java language program.

17. The system according to claim 15, wherein said hardware logic executes .NET language program.

18. The system according to claim 1, wherein said native program indicates to said co-processor a computer program of said plurality of computer programs, which said hardware logic is required to execute, by writing at least one datum.

19. The system according to claim 18, wherein said datum is a pointer to the composite data structure corresponding to said computer program, whereby said native program can control scheduling between said plurality of computer programs by writing said pointer to a composite data structure into said co-processor's register.

20. The system according to claim 19, wherein said plurality of computer programs are Java language computer programs.

21. The system according to claim 1, wherein said plurality of composite data structures is a single composite data structure corresponding to all object oriented platform independent language technology computer programs active in said system.

22. The system according to claim 1, wherein said memory is non-volatile memory, whereby said plurality of composite data structures or a single composite data structure of said plurality of composite data structures is created and written to said non-volatile memory by a computer program executing on a different computer system.

23. A method for concurrent execution of a plurality of computer programs belonging to an object oriented platform independent language technology, by utilizing a co-processor, wherein a hardware logic included in said co-processor natively executes a plurality of instructions belonging to said object oriented platform independent language technology, comprising the steps of:
a) providing a processor;
b) providing memory consisting of a plurality of memory locations, accessible by both said processor and said co-processor;
c) providing a native program, which is used by the runtime environment of said object oriented platform independent language technology and executes on said processor;
d) loading each computer program of said plurality of computer programs into said memory;
e) creating a composite data structure in said memory corresponding to said computer program as a part of said loading operation;
f) including a software logic in said native program, which create said composite data structure;
g) providing said hardware logic to said co-processor to access a single or a plurality of said composite data structures resident in said memory;
h) executing a plurality of machine independent instructions of said object oriented platform independent language technology, by said hardware logic;
i) creating a plurality of objects with one or more attributes in said memory by said native program executing on said processor;
j) creating a plurality of object references by said native program;
k) modifying instructions of a plurality of methods of said plurality of computer programs by said software logic;
l) accessing of said attributes by said hardware logic; and
m) invocating the non-static methods of said plurality of computer programs by said hardware logic;

24. The method according to claim 23, wherein said object oriented platform independent language technology is Java technology language.

25. The method according to claim 23, wherein a plurality of components comprising said composite data structure, are arranged by said software logic such that any element of said components can be accessed by said hardware logic, by using one or more pointers to said composite data structure and indexing into said plurality of components, whereby said hardware logic can access any portion of said components in minimum cycles.

26. The method according to claim 25, wherein said components comprise a plurality of arrays of C programming language structures.

27. The method according to claim 25, wherein the indexes necessary for said indexing are derived by said hardware logic from one or more operands of said plurality of instructions.

28. The method according to claim 27, wherein said operands are included in said plurality of instructions.

29. The method according to claim 28, wherein said operands are resident in stack of one or more threads of said plurality of computer programs.

30. The method according to claim 29, wherein said plurality of platform independent language technology instructions are Java byte-codes, whereby said Java byte-codes are natively executed by said hardware logic in minimum clock cycles using indexes found inside said byte-codes and said stack of threads.

31. The method according to claim 30, wherein said operands are resident inside one or more registers of said co-processor.

32. The method according to claim 23, wherein said steps further comprise:
a) arranging said plurality of composite data structures such that using a pointer to a composite data structure of said plurality of composite data structures, all the composite data structures resident in said memory can be accessed; and
b) providing said hardware logic capability to access said plurality of composite data structures using said pointer to a single composite data structure of said plurality of composite data structures,
whereby said hardware logic can access said plurality of composite data structures without said native program intervention.

33. The method according to claim 32, wherein said steps further comprises the following steps executed by said hardware logic:
a) accessing all the composite data structures of said plurality of composite data structures;
b) choosing a composite data structure of said plurality of composite data structures; and
c) executing the computer program corresponding to said composite data structure,
whereby said hardware logic can schedule said computer program based on a scheduling algorithm without intervention of a scheduler executing on said processor.

34. The method according to claim 23, wherein said steps further comprise said native program:
a) placing a plurality of static object references of said plurality of object references and the number of said static object references present in a loaded class, inside said composite data structure at pre-defined locations, of which said hardware logic is aware of,
whereby said hardware logic can reach said static object references to aid garbage collecting of unreachable objects.

35. The method according to claim 23, wherein said steps further comprise said native program:
a) placing a plurality of non static object references of said plurality of object references and the number of said non static object references present in an object, inside said object and at a pre-defined location inside a class information corresponding to said object respectively, of which said hardware logic is aware of,
whereby said hardware logic can reach said non static object references to aid garbage collecting of unreachable objects.

36. The method according to claim 23, wherein the object references of said plurality of object references comprises:
a) a class index to access class information present inside said composite data structure; and
b) an object index to access object information present inside said, composite data structure,
whereby said hardware logic can utilize the components in an object reference of said object references to derive all necessary information pertaining to said object reference during the course of program execution in minimum cycles by employing indexing.

37. The method according to claim 36, wherein said step of modifying instructions of a plurality of methods of said plurality of computer programs by said software logic leads to modification of operands of a plurality of processor independent instructions used to read and write said attributes, such that the modified operands include an attribute offset corresponding to the attribute indicated by said operands,
whereby said hardware logic can derive the appropriate location of said attributes in a data cache or said memory.

38. The method according to claim 37, wherein said hardware logic accesses said attributes using:
a) said class index;
b) said object index; and
c) said attribute offset.

39. The method according to claim 38, wherein said hardware logic natively executes a plurality of Java byte-codes.

40. The method according to claim 39, wherein the sequence of steps of said hardware logic to access said attributes comprises:
a) using said class index, said object index and said attribute offset in conjunction to look up a plurality of data cache slot tags to detect presence of a cached copy of the appropriate part of an object of said plurality of objects in said data cache;
b) executing step (c) in case said appropriate part of said object is present in said data cache otherwise executing step (e);
c) deriving the slot of said data cache in which said appropriate part of said object's cached copy is detected;
d) using said slot and said attribute offset accessing said attribute's location inside said slot, completing the access operation;
e) using said class index to index into an array of class information present in said composite data structure;
f) deriving an appropriate class information;
g) deriving an array of object information present at a well known location inside said appropriate class information;
h) using said object index indexing into said array of object information to derive the object information of said object;
i) deriving an address of said object's attributes in said memory, from a well known location inside said object information;
j) using said attribute offset and said address reading said appropriate part of said object into a data cache slot of said data cache;
k) updating the data cache slot tag corresponding to said data cache slot;
l) step (a) is repeated,
whereby said hardware logic can access said attributes without intervention of said native program.

41. The method according to claim 36, wherein said step of modifying instructions of a plurality of methods of said plurality of computer programs by said software logic, leads to modification of operands of a plurality of instructions used to invoke said non-static methods, such that the modified operands include a method index, whereby said hardware logic can access instructions and information necessary for invoking said non-static methods.

42. The method according to claim 41, wherein said hardware logic invokes said non-static methods using:
a) said class index; and
b) said method index.

43. The method according to claim 42, wherein said hardware logic natively executes a plurality of Java byte-codes.

44. The method according to claim 42, wherein the sequence of steps of said hardware logic to invoke said non-static method using said object comprises:
a) using said class index and said method index in conjunction to look up a plurality of method cache slot tags to detect presence of a cached copy of instructions and information pertaining to said non static method in a method cache;
b) executing step (c) upon detecting said cached copy of instructions and information pertaining to said non static method in a slot of said method cache, otherwise step (d) is executed;
c) invoking said non static method using said cached copy of instructions and information pertaining to said non static method detected in said slot;
d) using said class index to index into an array of class information present in a composite data structure of said plurality of composite data structures;
e) deriving a class information corresponding to said class index;
f) using said method index and a pointer to a method information array present at a well known location in said class information, accessing the method information and instructions pertaining to said non-static method;
g) reading said method information and instructions into a method cache slot of said method cache;
h) updating the method cache slot tag corresponding to said method cache slot such that looking up using said class index and said method index in conjunction will now lead to said method cache slot being identified as holding said method information and instructions; and
i) step (a) is repeated,
whereby said hardware logic can invoke said non-static method using said cached copy of instructions and information, without intervention of said native program.

45. The method according to claim 23, wherein said steps further comprise said native program:
a) writing datum indicating said composite data structure, to a location pointed by a memory address,
whereby scheduling of the computer program corresponding to said composite data structure is achieved.

46. The method according to claim 45, wherein said datum is a pointer to said composite data structure.

47. The method according to claim 46, wherein said composite data structure corresponds to a Java program.

48. The method according to claim 23, wherein said step of loading each computer program of said plurality of computer programs by said native program comprises of steps:
a) parsing one or more executables belonging to said computer program;
b) creating said composite data structure in said memory corresponding to said computer program;
c) initializing a plurality of fields of the components of said composite data structure;
d) indicating to said hardware logic the entry method of said computer program, by doing write access to memory locations;
e) indicating to said hardware logic the presence of said composite data structure in said memory, by doing write access to memory locations; and
f) indicating said hardware logic to operate, by doing write access to memory locations,
whereby said entry method of said computer program can be executed by said hardware logic.

49. The method according to claim 48, wherein said memory locations are memory mapped register of said co-processor or the memory locations of said memory.

50. The method according to claim 49, wherein said plurality of instructions is Java byte-codes comprising said composite data structure.

51. The method according to claim 23, wherein said steps further comprise:
a) providing said co-processor with a data cache,
whereby copies of objects or parts of objects resident in said memory can be cached for quick access.

52. The method according to claim 23, wherein said steps further comprise:
a) providing said co-processor with a method cache, whereby said plurality of instructions resident in said memory can be cached for quick access.

53. The method according to claim 23, wherein
a) said memory is non-volatile memory;
b) said software logic is not included in said native program; and
c) said software logic is included in a computer program executing on a different computer system,
whereby said computer program executing on a different computer system creates said composite data structure in said non-volatile memory for future processing by said hardware logic.

54. The method according to claim 23, wherein said steps further comprise:
a) providing said software logic the ability to convert one or more executables belonging to the computer program of a different object oriented platform independent language technology, to the format of said composite data structure; and
b) providing said software logic the ability to replace instructions of said different object oriented platform independent language technology with corresponding instructions that said hardware logic can natively execute, such that program logic of methods belonging to said computer program are not altered,
whereby programs from a different object oriented platform independent language technology, say .NET, can be executed by a hardware logic designed to natively execute Java.
